(19) United States
(12) Patent Application Publication
(10) Pub. No.: US 2022/0250257 A1
(43) Pub. Date: Aug. 11, 2022

(54) GRIPPING TOOL FOR A ROBOTIC ARM

(71) Applicant: NW Farms, Inc., Auburn, WA (US)

(72) Inventor: Robert Bryce Clemmer, Auburn, WA (US)

(21) Appl. No.: 17/171,825

(22) Filed: Feb. 9, 2021

(51) Int. Cl. B25J 15/06; B25J 13/08

(52) U.S. Cl. CPC B25J 15/0625; B25J 13/085

(57) ABSTRACT

A gripping tool mountable on a robotic arm. The gripping tool includes one or more suction cups and a plurality of clamps. The one or more suction cups are oriented to adhere to a surface. The plurality of clamps are oriented to clamp onto opposite edges of the surface.

### BACKGROUND OF THE INVENTION

### Field of the Invention

The present invention is directed generally to tools configured to be installed on robotic arms.

### Description of the Related Art

Robotic arms are used in many applications and to implement many automated processes. Robotic arms may be configured for particular applications by installing specialized tooling on a free end of the robotic arm. For example, a robotic arm may be configured or customized to grip particular items by installing a gripping tool on the free end of the robotic arm.

### BRIEF DESCRIPTION OF THE SEVERAL VIEWS OF THE DRAWING(S)

Various embodiments in accordance with the present disclosure will be described with reference to the following drawings.

FIG. 1 is a block diagram illustrating components of an indoor hydroponic vertical farm system.

FIG. 2 is a top perspective view of an embodiment of the indoor hydroponic vertical farm system illustrated in FIG. 1.

FIG. 3 is a top view of an overhead conveyor system of the system of FIG. 2.

FIG. 4 is a front perspective view of the system of FIG. 2. FIG. 5 is a front perspective view of a portion of a lighting system of the system of FIG. 2.

FIG. 6 is a front perspective view of a carrier assembly carrying a plurality of vertical grow tower assemblies of the system of FIG. 2.

FIG. 7 is a front perspective view of a front face plate of one of the vertical grow tower assemblies of FIG. 6.

FIG. 8A is a back perspective view of a tower frame of one of the vertical grow tower assemblies of FIG. 6 shown with a back face plate and a hook being inserted into the tower frame.

FIG. 8B is a top perspective view of the tower frame of FIG. 8A. FIG. 9 is a bottom perspective view of one of the vertical grow tower assemblies of FIG. 6.

FIG. 10 is a top perspective view of the vertical grow tower assembly of FIG. 9.

FIG. 11 is a back perspective view of the hook of the vertical grow tower assembly of FIG. 9.

FIG. 12 is an exploded perspective view of irrigation funnels of the vertical grow tower assembly of FIG. 9.

FIG. 13 is a top perspective view of the carrier assembly and vertical grow tower assemblies of FIG. 6 omitting the overhead conveyor system and providing a view of the vertical grow tower assemblies receiving water and nutrients from a watering system.

FIG. 14 is a front perspective view of a load bar of the carrier assembly of FIG. 6 illustrated supporting the hook of one of the vertical grow tower assemblies.

FIG. 15 is a diagram of a hardware environment and an operating environment in which one or more computer systems of the system of FIG. 1 may be implemented.

FIG. 16 is a perspective view of an effector configured to be installed on a free end of a robotic arm.

FIG. 17 is a perspective view of a front gripping side of the effector of FIG. 16.

FIG. 18 is a partially exploded perspective view of the effector of FIG. 16.

FIG. 19 is a perspective view of a back side of the effector of FIG. 16 gripping the tower frame of one of the vertical grow tower assemblies of FIG. 6.

FIG. 20 is a block diagram illustrating components of the effector of FIG. 16 that vacuum clamp and mechanically clamp onto the vertical grow tower assembly.

FIG. 21 is a perspective view of an underside of the effector of FIG. 16 gripping the tower frame.

FIG. 22 is a perspective view of a splitter mounted on the effector of FIG. 16.

FIG. 23 is a perspective view of an underside of an assembly of the effector of FIG. 16

FIG. 24 is a flow diagram of a method that may be performed by an application illustrated in FIG. 1.

Like reference numerals have been used in the figures to identify like components.

### DETAILED DESCRIPTION OF THE INVENTION

### Overview

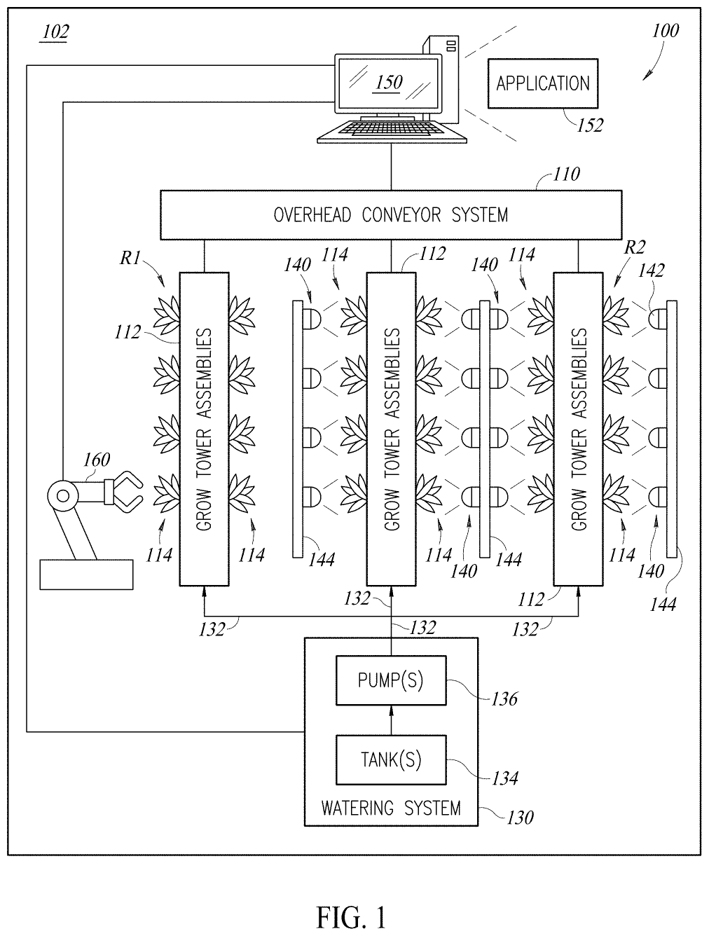

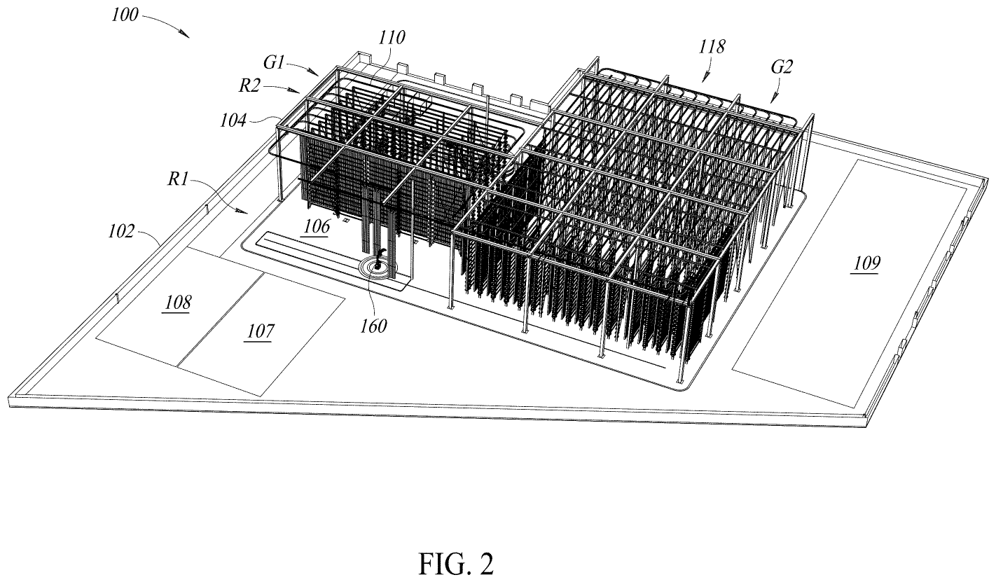

FIG. 1 is a block diagram illustrating components of a hydroponic vertical farm system 100 configured to be installed inside a building 102 and to be partially or fully automated. Referring to FIG. 2, a support structure 104 may be constructed inside the building 102 and components of the system 100 may be mounted to the support structure 104. In this manner, the system 100 may include a standard set of components that may be installed inside any building of a suitable size to accommodate the support structure 104 by simply first installing the support structure 104 inside the building 102 and then mounting the system 100 to the support structure 104.

The building 102 may be divided into regions 106-109 that may be used for specific purposes. For example, the region 106 may be occupied by the system 100, the region 107 may be dedicated to planting and/or germinating plants 114 (see FIGS. 1, 6, 9, and 13), the region 108 may be used for harvesting and/or packaging the plants 114, and the region 109 may be used for office space.

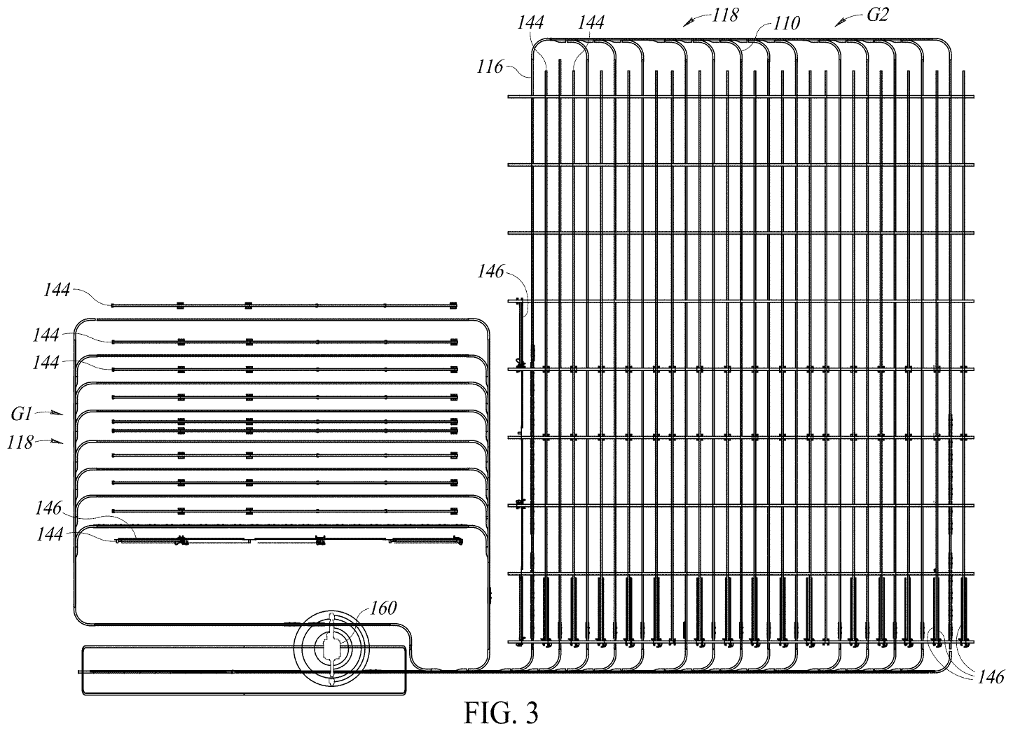

Referring to FIG. 1, the system 100 includes an overhead conveyor system 110 (e.g., built by Ultimation Industries) from which vertical grow tower assemblies 112 are hung. The overhead conveyor system 110 defines a closed loop path 116 (see FIG. 3) along which the vertical grow tower assemblies 112 travel. In the embodiment illustrated, the overhead conveyor system 110 is configured to define regions R1 and R2 within the region 106 (see FIG. 2). The region R1 is used to add newly planted ones of the vertical grow tower assemblies 112 to the overhead conveyor system 110 and to remove ones of the vertical grow tower assemblies 112 supporting fully grown plants from the overhead conveyor system 110 for harvesting. After the newly planted vertical grow tower assemblies are added to the region R1, the overhead conveyor system 110 transports the newly planted vertical grow tower assemblies to the region R2 where the plants 114 are allowed to grow. Within the region R2, the overhead conveyor system 110 may branch and define a plurality of parallel rows 118 (see FIGS. 2 and 3) along which the vertical grow tower assemblies 112 hang as the plants 114 grow. In the embodiment illustrated in FIG. 2, the overhead conveyor system 110 organizes the parallel rows 118 into two groups G1 and G2 but this is not a requirement. As shown in FIG. 3, the first group G1 may be substantially orthogonal to the second group G2. In the embodiment illustrated, the first group G1 includes eight rows and the second group G2 includes 15 rows. However, this is not a requirement.

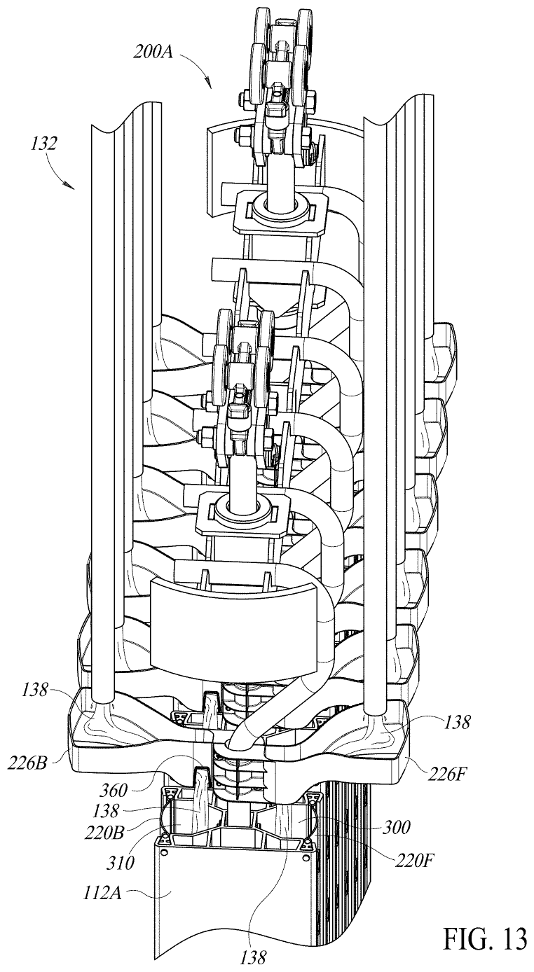

Referring to FIG. 1, the system 100 includes a watering system 130 that delivers water and nutrients 138 (see FIG. 13) to the plants 114. The watering system 130 may be implemented as a drip system that delivers water to the vertical grow tower assemblies 112 from above. The watering system 130 may include water pipes 132 (e.g., rubber water pipes or hoses) positioned on top of the overhead conveyor system 110 and configured to provide the water and nutrients 138 (see FIG. 13) directly to each of the vertical grow tower assemblies 112. The watering system 130 may include one or more tanks 134 configured to hold the water and nutrients 138 (see FIG. 13). The watering system 130 may include one or more pumps 136 configured to pump the water and nutrients 138 (see FIG. 13) from the tank(s) 134 through the water pipes 132 and to the plants 114.

The system 100 includes a lighting system 140 that delivers artificial light to the plants 114 instead and in place of natural sunlight. The light delivered is configured to satisfy the needs of the plants 114. The lighting system 140 includes lights 142 that may be implemented as strips or strings of light emitting diodes (“LEDs”) 146 (see FIGS. 3-5). For example, referring to FIG. 3, two-sided LED lights may be strung between adjacent ones of the rows 118. In the embodiment illustrated in FIG. 1, the lights 142 are mounted on one or more racks 144 positions alongside the rows 118.

The system 100 includes at least one computer system 150 configured to execute an application 152. When executing the application 152, the computer system(s) 150 is configured to control the overhead conveyor system 110. Thus, the overhead conveyor system 110 is automated and operated by the application 152 executing on the computer system(s) 150. The application 152 is configured to instruct the overhead conveyor system 110 where to place each of the vertical grow tower assemblies 112 within the system 100. For example, the overhead conveyor system 110 may include a number of switches that determine whether the vertical grow tower assemblies 112 traveling on a segment of the overhead conveyor system 110 turn down a particular one of the rows 118 (see FIGS. 2 and 3) or continue traveling on the segment. The vertical grow tower assemblies 112 may be placed within the system 100 in accordance with a floor plan. The application 152 may also be configured to control the watering system 130 and/or the lighting system 140. In the embodiment illustrated, the application 152 is connected to the watering system 130 and determines when the plants 114 supported by each of the vertical grow tower assemblies 112 receives a portion of the water and nutrients 138 (see FIG. 13). Similarly, the application 152 may be connected to the lighting system 140 and configured to determine when the plants 114 within each of the rows 118 (see FIGS. 2 and 3) or portions of the rows 118 receive light.

The system 100 may include one or more automated robots configured to plant the plants 114 in the vertical grow tower assemblies 112, to attach the newly planted vertical grow tower assemblies 112 to the overhead conveyor system 110, to detach the vertical grow tower assemblies 112 from the overhead conveyor system 110 when the plants 114 are ready to be harvested, and to harvest the plants 114. In the embodiment illustrated, the system 100 includes a robot 160 positioned in the region R1. The robot 160 is positioned and configured to attach the vertical grow tower assemblies 112 to the overhead conveyor system 110 and to detach the vertical grow tower assemblies 112 from the overhead conveyor system 110 when the plants 114 are ready for harvesting. The robot 160 may be implemented as a robotic arm, such as a FANUC R-2000Ia/165F sold by FANUC America Corporation.

The application 152 may be configured to control the robot 160. For example, the application 152 may instruct the robot 160 to plant the plants 114 in the vertical grow tower assemblies 112. Then, the application 152 may instruct the robot 160 to attach the vertical grow tower assemblies 112 to the overhead conveyor system 110. Next, the application 152 may instruct the overhead conveyor system 110 where to place each of the vertical grow tower assemblies 112 within the system 100 to allow the plants 114 to grow. The application 152 may instruct the lighting system 140 to provide artificial light to the plants 114 as needed and the application 152 may instruct the watering system 130 to provide the water and nutrients 138 (see FIG. 13) to the plants 114 as needed. Once the plants 114 growing in a particular one of the vertical grow tower assemblies 112 are ready to be harvested, the application 152 may direct the overhead conveyor system 110 to position that particular vertical grow tower in the region R1 alongside the robot 160. Then, the application 152 may instruct the robot 160 to detach the particular vertical grow tower from the overhead conveyor system 110 so that the plants 114 may be harvested. In some embodiments, the application 152 may instruct the robot 160 to harvest the plants 114 from the particular vertical grow tower assembly. After the plants 114 have been removed from the particular vertical grow tower, the particular vertical grow tower may be replanted and hung from the overhead conveyor system 110 again. Because the system 100 is operated indoors, the plants 114 may be germinated, planted, and grown continuously year round.

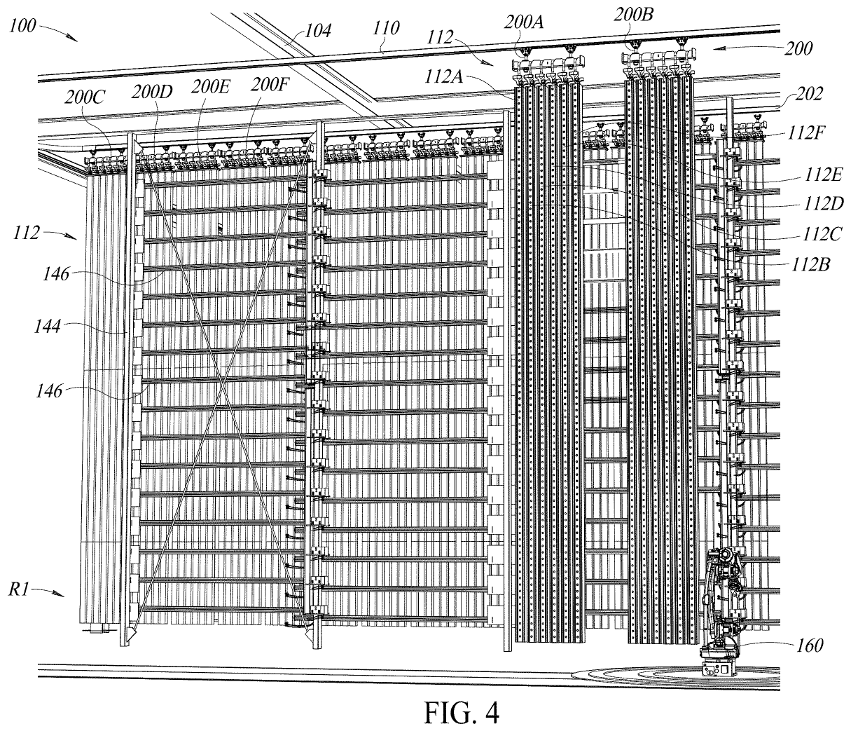

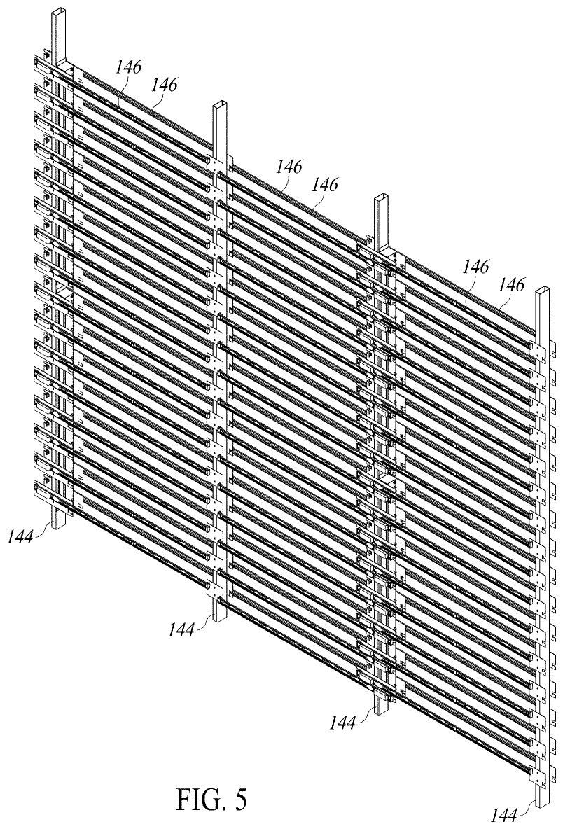

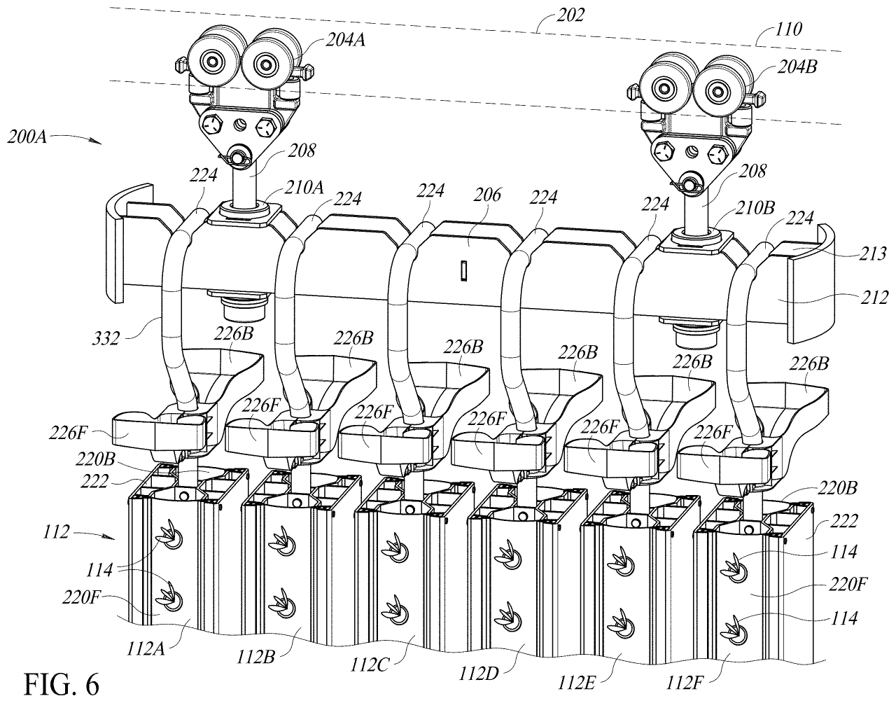

As shown in FIG. 4, the overhead conveyor system 110 may include a plurality of carrier assemblies 200 (e.g., carrier assemblies 200A-200F) configured to travel along a track 202. Referring to FIG. 6, in the embodiment illustrated, each of the carrier assemblies 200 (e.g., the carrier assembly 200A) includes one or more trolley assemblies 204A and 204B and a load bar 206. The trolley assemblies 204A and 204B are substantially identical to one another and are configured to move along the track 202. In the embodiment illustrated, the trolley assemblies 204A and 204B are spaced apart from one another and the load bar 206 extends therebetween. The trolley assemblies 204A and 204B space the load bar 206 apart vertically from the track 202. Each of the trolley assemblies 204A and 204B includes a connector portion 208.

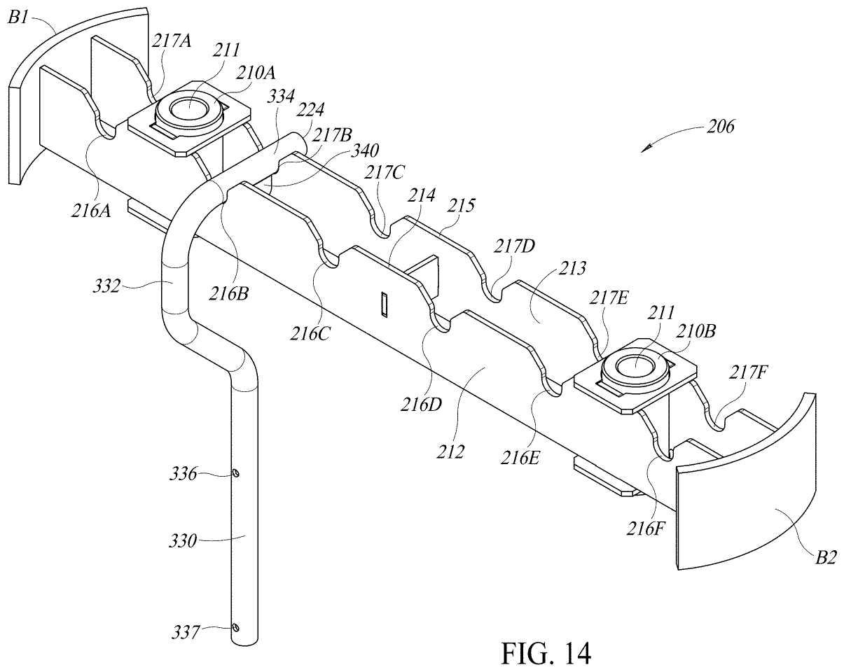

Referring to FIG. 14, the load bar 206 includes connectors 210A and 210B configured to be connected to the connector portions 208 (see FIG. 6) of the trolley assemblies 204A and 204B (see FIG. 6), respectively. Referring to FIG. 6, the connector portions 208 may be implemented as generally cylindrically shaped rods. In the embodiment illustrated in FIG. 14, the connectors 210A and 210B have each been implemented as a generally cylindrically shaped bearing housing having an open-ended vertical through-channel 211 therein. The through-channels 211 of the connectors 210A and 210B are configured to receive the connector portions 208 (see FIG. 6) of the trolley assemblies 204A and 204B (see FIG. 6), respectively. Referring to FIG. 6, the vertical through-channel 211 (see FIG. 14) of the connector 210A is configured to allow the trolley assembly 204A to rotate therein as the carrier assembly 200A travels around curved portions of the track 202. Similarly, the vertical through-channel 211 (see FIG. 14) of the connector 210B is configured to allow the trolley assembly 204B to rotate therein as the carrier assembly 200A travels around curved portions of the track 202. Bearings may be positioned inside the through-channels 211 (see FIG. 14) between the connectors 210A and 210B and the connector portions 208 of the trolley assemblies 204A and 204B, respectively.

Referring to FIG. 14, the connectors 210A and 210B are mounted between parallel first and second rails 212 and 213. The first and second rails 212 and 213 are substantially identical to one another. The first rail 212 includes an upper edge 214 with seats 216A-216F formed therein, and the second rail 213 includes an upper edge 215 with seats 217A-217F formed therein. In the embodiment illustrated, the seats 216A-216F have been implemented as cutouts formed in the upper edge 214 and the seats 217A-217F have been implemented as cutouts formed in the upper edge 215. The seats 216A-216F are aligned with the seats 217A-217F, respectively.

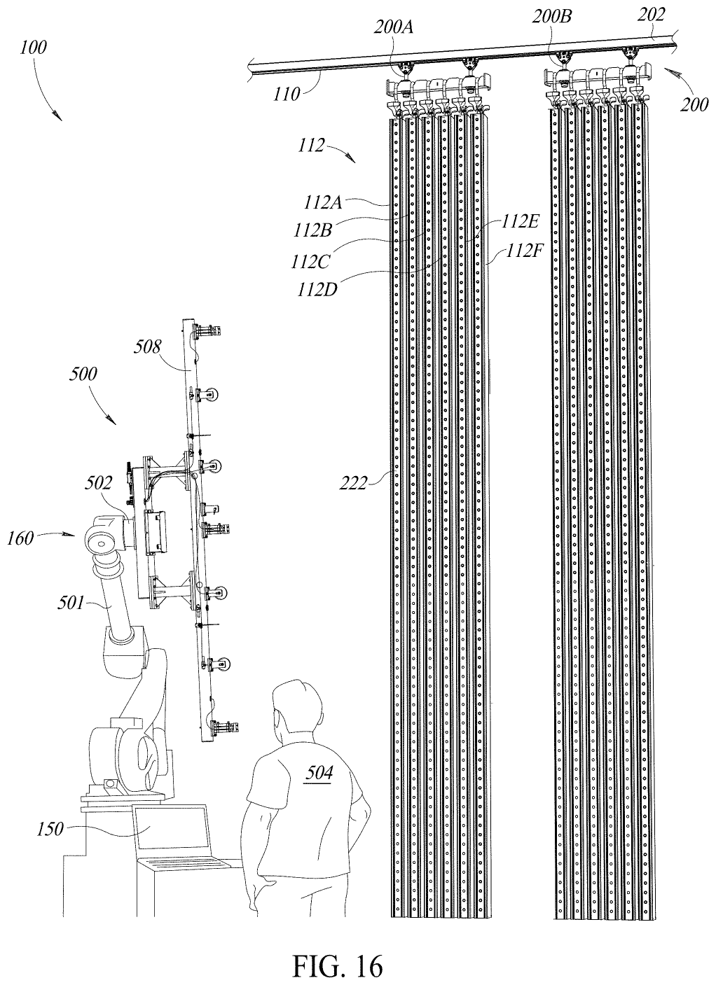

The load bar 206 includes first and second bumpers B1 and B2. The first and second rails 212 and 213 each extend from the first bumper B1 to the second bumper B2. The first and second bumpers B1 and B2 may be curved and are configured to protect the first and second rails 212 and 213 from collisions with other ones of the carrier assemblies 200 (see FIGS. 4 and 16).

As shown in FIG. 6, a predetermined number (e.g., six) of the vertical grow tower assemblies 112 (e.g., vertical grow tower assemblies 112A-112F) may be hung together side-by-side on the load bar 206. For example, the carrier assembly 200A is configured to carry the vertical grow tower assemblies 112A-112F along the track 202 as a unit. The vertical grow tower assemblies 112A-112F are mounted in the seats 216A-216F (see FIG. 14), respectively, of the first rail 212 and the seats 217A-217F (see FIG. 14), respectively, of the second rail 213.

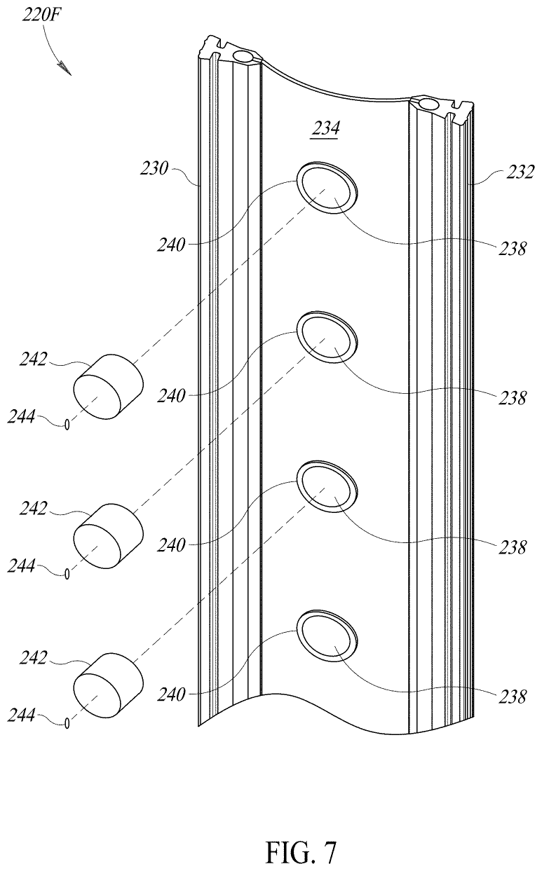

Each of the vertical grow tower assemblies 112 includes a front face plate 220F, a back face plate 220B, a tower frame 222, a hook 224, a front irrigation funnel 226F, and a back irrigation funnel 226B. The front and back face plates 220F and 220B are substantially identical to one another and configured to be slid into and out of the tower frame 222. Referring to FIG. 7, the front and back face plates 220F and 220B (see FIGS. 6, 9, and 13) each have a first edge portion 230 opposite a second edge portion 232 and a central portion 234 that extends from the first edge portion 230 to the second edge portion 232. In the embodiment illustrated in FIG. 9, the central portion 234 curves outwardly away from the tower frame 222. In other words, the central portion 234 may be generally convex with respect to the tower frame 222. The first and second edge portions 230 and 232 (see FIG. 7) are configured to be slid into the tower frame 222 and to anchor the front and back face plates 220F and 220B to the tower frame 222. Referring to FIG. 7, in the embodiment illustrated, the first and second edge portions 230 and 232 taper outwardly away from the central portion 234. Thus, the first and second edge portions 230 and 232 may have a generally triangular cross-sectional shape that is thinnest along the central portion 234 and thicker further away from the central portion 234.

In the embodiment illustrated in FIG. 7, the front and back face plates 220F and 220B (see FIGS. 6, 9, and 13) each include a plurality of cups or baskets 240. The baskets 240 may be arranged in a linear pattern that extends along each of the front and back face plates 220F and 220B (see FIGS. 6, 9, and 13). Each of the baskets 240 has an opening 238 configured to receive growth media 242 in which at least one seed 244 has been or will be planted. The seeds 244 may subsequently be allowed to germinate in the baskets 240. For example, the seeds 244 may be planted in the growth media 242 in the baskets 240 of the front face plate 220F and allowed to germinate in the baskets 240 before the front face plate 220F is slid into the tower frame 222. Alternatively, the seeds 244 may be planted in the growth media 242 and allowed to germinate. Then, the growth media 242 may be relocated to the baskets 240 of the front face plate 220F shortly before the front face plate 220F is slid into the tower frame 222. The same planting procedure performed with respect to the front face plate 220F may be performed with respect to the back face plate 220B (see FIGS. 6, 8A, 9, and 13). Additionally, the same harvesting procedure may be performed with respect to the front and back face plates 220F and 220B.

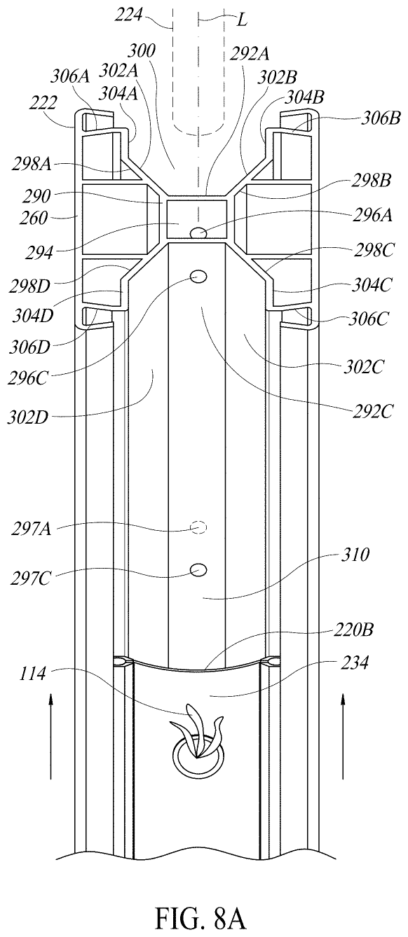

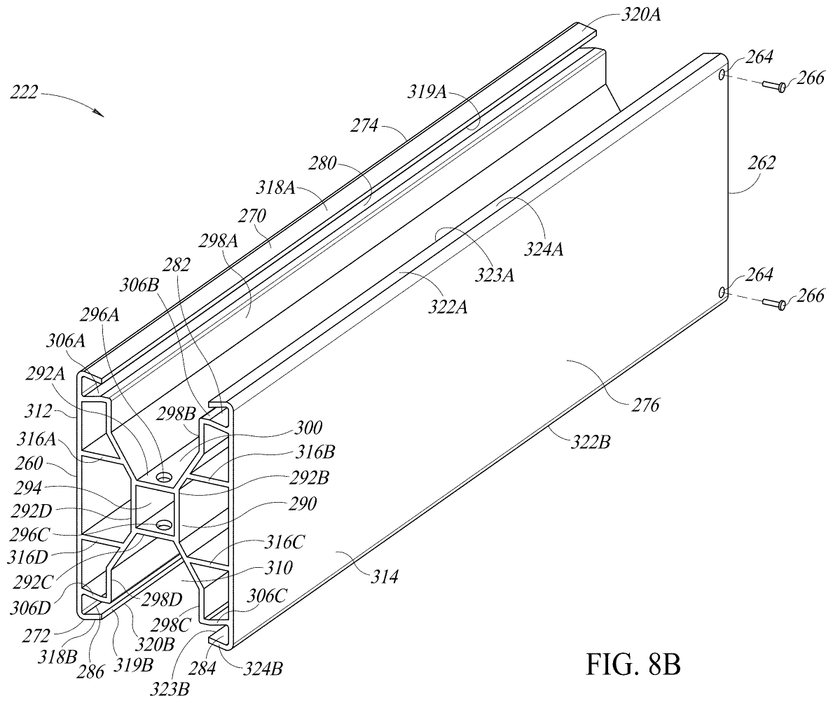

Referring to FIG. 8A, the tower frame 222 extends along a longitudinal axis “L” that is oriented vertically when the tower frame 222 is suspended from the overhead conveyor system 110 (see FIGS. 1-4, 6, and 16). The tower frame 222 may have a height ranging from about 20 feet to about 30 feet. For example, the tower frame 222 may be 20 feet tall. Referring to FIG. 8B, the tower frame 222 has a top portion 260 opposite a bottom portion 262. The bottom portion 262 has through-holes 264 formed therein configured to receive pins 266. In the embodiment illustrated, the tower frame 222 has a front facing side 270 opposite a back facing side 272 and a first side portion 274 opposite a second side portion 276. The front and back facing sides 270 and 272 are mirror images of one another and the first and second side portions 274 and 276 are mirror images of one another.

At the front facing side 270, the tower frame 222 has a longitudinally extending first channel or groove 280 positioned on the first side portion 274 and a longitudinally extending second channel or groove 282 positioned on the second side portion 276. The first and second grooves 280 and 282 are juxtaposed laterally from one another and configured to receive the first and second edge portions 230 and 232 (see FIG. 7), respectively, of the front face plate 220F (see FIGS. 6, 7, 9, and 13). Referring to FIG. 9, the front face plate 220F is configured to slide within the first and second grooves 280 and 282 longitudinally. As shown in FIG. 9, the grooves 280 and 282 may each have generally triangular cross-sectional shapes that helps maintain the first and second edge portions 230 and 232 (see FIG. 7), respectively, of the front face plate 220F therein.

Referring to FIG. 8B, at the back facing side 272, the tower frame 222 has a longitudinally extending third channel or groove 284 positioned on the second side portion 276 and a longitudinally extending fourth channel or groove 286 positioned on the first side portion 274. The third and fourth grooves 284 and 286 are juxtaposed laterally from one another and configured to receive the first and second edge portions 230 and 232 (see FIG. 7), respectively, of the back face plate 220B (see FIGS. 6, 8A, 9, and 13). As shown in FIG. 9, the grooves 284 and 286 may each have generally triangular cross-sectional shapes that helps maintain the first and second edge portions 230 and 232 (see FIG. 7), respectively, of the back face plate 220B therein.

The through-holes 264 (see FIG. 8B) formed in the bottom portion 262 are in communication with the first and third grooves 280 and 286 and/or the second and fourth grooves 282 and 284. In other words, referring to FIG. 8B, one of the through-holes 264 is positioned to be in communication with the groove 280 or the groove 282 and a different one of the through-holes 264 is positioned to be in communication with the groove 284 or the groove 286. Thus, the pins 266 block at least one of the first and second grooves 280 and 282 and at least one of the third and fourth grooves 284 and 286. Referring to FIG. 9, the pins 266 are configured to be inserted into the through-holes 264 (see FIG. 8B) to prevent the front and back face plates 220F and 220B from sliding downwardly and at least partially exiting the tower frame 222 through the bottom portion 262 when the tower frame 222 is in a vertical orientation. The pins 266 may be inserted into the through-holes 264 (see FIG. 8B) in communication with the second and fourth grooves 282 and 284 when the tower frame 222 is positioned on the first side portion 274. Similarly, as shown in FIG. 9, the pins 266 may be inserted into the through-holes 264 (see FIG. 8B) in communication with the first and third grooves 280 and 286 when the tower frame 222 is positioned on the second side portion 276.

Referring to FIG. 8B, the tower frame 222 has a longitudinally extending central portion 290. In the embodiment illustrated, the central portion 290 has a generally square cross-sectional shape. The central portion 290 includes longitudinally extending sidewalls 292A-292D that define a longitudinally extending open-ended central through-channel 294. The sidewalls 292A and 292C are opposite one another and the sidewalls 292B and 292D are opposite one another. Referring to FIG. 8A, the sidewall 292A has through-holes 296A and 297A formed therein and the sidewall 292C has through-holes 296C and 297C formed therein. The through-holes 296A and 296C are aligned with one another across the central through-channel 294 and the through-holes 296A and 296C are aligned with one another across the central through-channel 294.

In the embodiment illustrated in FIG. 8B, a sidewall 298A extends outwardly from an intersection of the sidewalls 292A and 292D and a sidewall 298B extends outwardly from an intersection of the sidewalls 292A and 292B. A longitudinally extending open-ended front through-channel 300 is defined between the sidewalls 292A, 298A, and 298B. In the embodiment illustrated in FIG. 8A, the sidewall 298A has an angled proximal portion 302A, an intermediate portion 304A, and a distal portion 306A. Similarly, the sidewall 298B has an angled proximal portion 302B, an intermediate portion 304B, and a distal portion 306B. The angled proximal portions 302A and 302B are each attached to the central portion 290 and widen the front through-channel 300. The intermediate portions 304A and 304B are substantially parallel with one another. The distal portions 306A and 306B are bent outwardly away from the front through-channel 300 in opposite directions.

Referring to FIG. 8B, a sidewall 298C extends outwardly from an intersection of the sidewalls 292B and 292C. Similarly, a sidewall 298D extends outwardly from an intersection of the sidewalls 292C and 292D. A longitudinally extending open-ended back through-channel 310 is defined between the sidewalls 292C, 298C, and 298D. In the embodiment illustrated in FIG. 8A, the sidewall 298C has an angled proximal portion 302C, an intermediate portion 304C, and a distal portion 306C. Similarly, the sidewall 298D has an angled proximal portion 302D, an intermediate portion 304D, and a distal portion 306D. The angled proximal portions 302C and 302D are each attached to the central portion 290 and widen the back through-channel 310. The intermediate portions 304C and 304D are substantially parallel with one another. The distal portions 306C and 306D are bent outwardly away from the front through-channel 300 in opposite directions. In the embodiment illustrated, the distal portions 306A and 306D bend toward one another and the distal portions 306B and 306C bend toward one another.

Referring to FIG. 8B, a first plate or member 312 is attached to free ends of the distal portions 306A and 306D and a second plate or member 314 is attached to free ends of the distal portions 306B and 306C. Supports 316A and 316D may extend between the first member 312 and the sidewalls 298A and 298D, respectively. Similarly, supports 316B and 316C may extend between the second member 314 and the sidewalls 298B and 298C, respectively.

A first distal portion 318A of the first member 312 extends outwardly beyond the distal portion 306A and a second distal portion 318B of the first member 312 extends outwardly beyond the distal portion 306D. The first distal portion 318A may be bent inwardly near its first edge 319A to define a first flange 320A that extends toward the front through-channel 300. The first groove 280 is defined between the first flange 320A and the distal portion 306A. The second distal portion 318B may be bent inwardly near its second edge 319B to define a second flange 320B that extends toward the back through-channel 310. The fourth groove 286 is defined between the second flange 320B and the distal portion 306D.

A first distal portion 322A of the second member 314 extends outwardly beyond the distal portion 306B and a second distal portion 322B of the second member 314 extends outwardly beyond the distal portion 306C. The first distal portion 322A may be bent inwardly near its first edge 323A to define a first flange 324A that extends toward the front through-channel 300. The second groove 282 is defined between the first flange 324A and the distal portion 306B. The second distal portion 322B may be bent inwardly near its second edge 323B to define a second flange 324B that extends toward the back through-channel 310. The third groove 284 is defined between the second flange 324B and the distal portion 306C.

Referring to FIG. 9, the front and back through-channels 300 and 310 are positioned behind the front and back face plates 220F and 220B, respectively. As mentioned above, the central portions 234 of the front and back face plates 220F and 220B curve outwardly and help enlarge the cross-sectional area of the front and back through-channels 300 and 310, respectively.

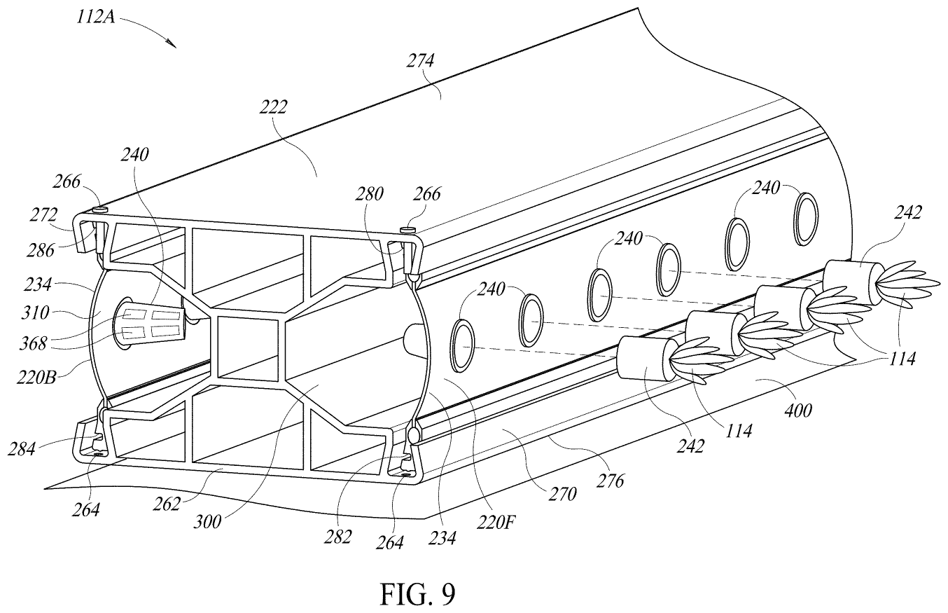

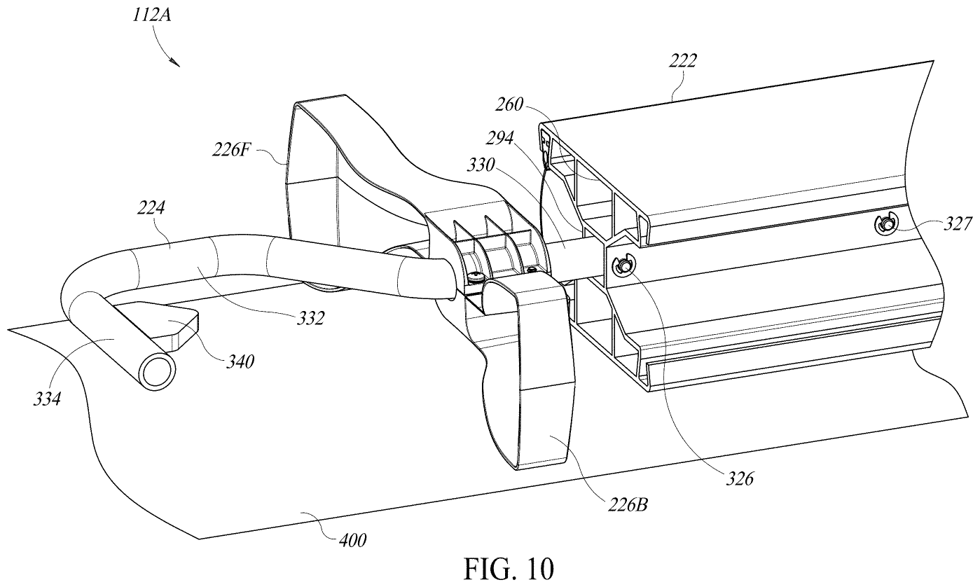

Referring to FIG. 10, the hook 224 may be attached to the tower frame 222 of the vertical grow tower assembly 112A. In the embodiment illustrated, the hook 224 is configured to be received inside the central through-channel 294 and held in place by pins 326 and 327. The pin 326 is inserted laterally through the through-holes 296A and 296C (see FIGS. 8A and 8B) of the tower frame 222 and the pin 327 is inserted laterally through the through-holes 297A and 297C (see FIG. 8A) of the tower frame 222 when the hook 224 is positioned inside the central through-channel 294 of the tower frame 222.

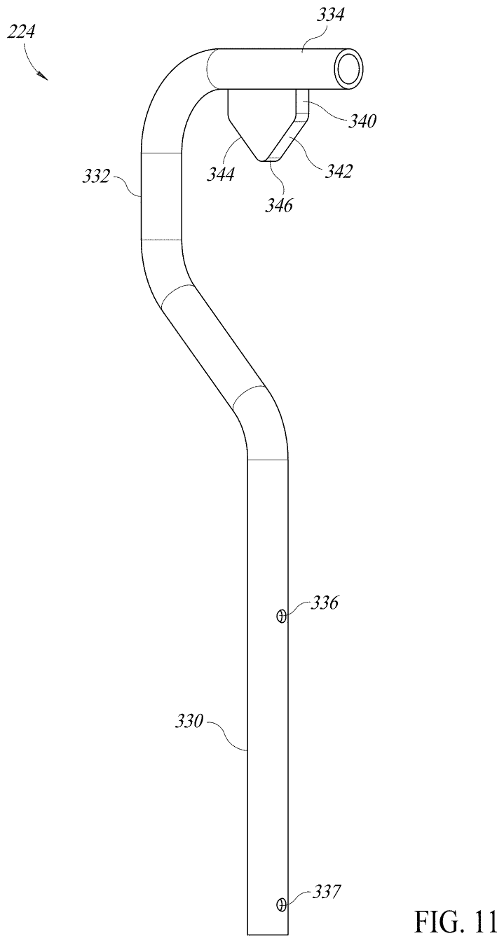

Referring to FIG. 11, the hook 224 may be constructed from a section of hollow tubing or pipe. The hook 224 includes a substantially linear lower portion 330, a curved intermediate portion 332, and a substantially linear upper portion 334. The lower and upper portions 330 and 334 may be substantially orthogonal with respect to one another. The lower portion 330 includes spaced apart through-holes 336 and 337 configured to receive the pins 326 and 327 (see FIG. 10), respectively. Thus, the through-hole 336 is positioned to be aligned with the through-holes 296A and 296C (see FIGS. 8A and 8B), and the through-hole 337 is positioned to be aligned with the through-holes 297A and 297C (see FIG. 8A). The lower portion 330 is configured to be aligned with the longitudinal axis “L” (see FIG. 8A) and inserted into the central through-channel 294. As shown in FIG. 6, the curved intermediate portion 332 is configured to curve partway around the load bar 206 to position the upper portion 334 (see FIGS. 10, 11, and 14) above the load bar 206 when, as shown in FIG. 10, the lower portion 330 is received inside the central through-channel 294. The upper portion 334 has a downwardly extending anchor projection 340. In the embodiment illustrated, the anchor projection 340 is generally planar and has a pentagonal outer shape. Referring to FIG. 11, the anchor projection 340 has angled edges 432 and 434 that intersect and terminate at a point 346 that is centered at and aligned with the lower portion 330.

Referring to FIG. 6, the hook 224 of each of the vertical grow tower assemblies 112A-112F is configured to be hung from the first and second rails 212 and 213 of the load bar 206. As mentioned above, the seats 216A-216F (see FIG. 14) are aligned with the seats 217A-217F (see FIG. 14), respectively, to receive the hooks 224 of the vertical grow tower assemblies 112A-112F, respectively. In other words, the aligned seats 216A and 217A are configured to receive the hook 224 of the vertical grow tower assembly 112A, the aligned seats 216B and 2176 are configured to receive the hook 224 of the vertical grow tower assembly 112B, the aligned seats 216C and 217C are configured to receive the hook 224 of the vertical grow tower assembly 112C, the aligned seats 216D and 217D are configured to receive the hook 224 of the vertical grow tower assembly 112D, the aligned seats 216E and 217E are configured to receive the hook 224 of the vertical grow tower assembly 112E, and the aligned seats 216F and 217F are configured to receive the hook 224 of the vertical grow tower assembly 112F. When the hooks 224 are so received, the anchor projection 340 (see FIGS. 10, 11, and 14) of each of the hooks 224 of the vertical grow tower assemblies 112A-112F are positioned between the first and second rails 212 and 213.

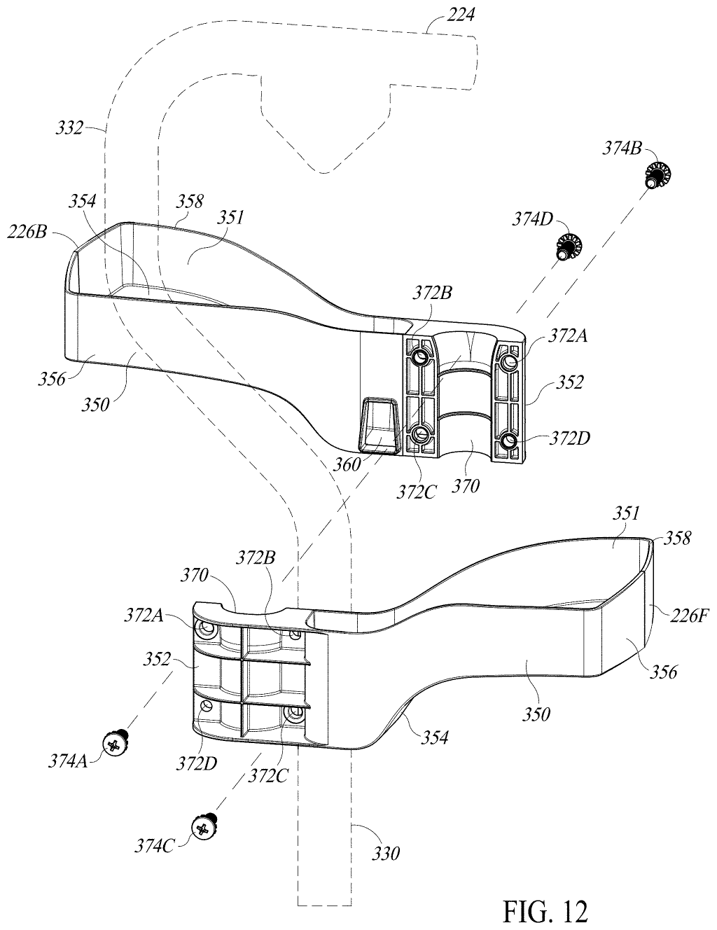

As mentioned above, referring to FIG. 6, the front and back irrigation funnels 226F and 226B are substantially identical to one another. Referring to FIG. 12, each of the front and back irrigation funnels 226F and 226B includes a water collection portion 350 attached to a connector portion 352. The water collection portion 350 may be generally cup or funnel shaped and defines a hollow interior 351 that opens upwardly. Optionally, the hollow interior 351 may be filled with a porous material (e.g., foam) that allows the water and nutrients 138 (see FIG. 13) to flow therethrough. In the embodiment illustrated, the water collection portion 350 includes a floor or base 354 surround by a sidewall 356 that together define the hollow interior 351. The sidewall 356 extends upwardly from the base 354 and has an upper free edge 358 defining an opening into the hollow interior 351. An opening 360 into the hollow interior 351 is formed in the sidewall 356. However, in alternate embodiments, the opening 360 may be formed in the base 354. In other words, at least one opening may be formed in the sidewall 356 and/or the base 354. The opening 360 may be formed near the base 354 and the connector portion 352. Any water and nutrients received inside the hollow interior 351 through the opening defined by the upper free edge 358 may exit the hollow interior 351 through the opening 360. The base 354 may be curved or tapered to help the water and nutrients 138 (see FIG. 13) flow toward the opening 360.

Referring to FIG. 13, the opening 360 of the front irrigation funnel 226F is positioned such that the water and nutrients 138 exiting the opening 360 of the front irrigation funnel 226F flow downwardly through the front through-channel 300 of the vertical grow tower assembly 112A. The baskets 240 (see FIGS. 7 and 9) of the front face plate 220F extend into the front through-channel 300 and receive at least a portion of the water and nutrients 138 flowing through the front through-channel 300. Thus, the front through-channel 300 provides a first pathway for the water and nutrients 138 to reach the roots of the plants 114 supported by the front face plate 220F. Similarly, the opening 360 of the back irrigation funnel 226B is positioned such that the water and nutrients 138 exiting the opening 360 of the back irrigation funnel 226B flow downwardly through the back through-channel 310 of the vertical grow tower assembly 112A. The baskets 240 (see FIGS. 7 and 9) of the back face plate 220B extend into the back through-channel 310 and receive at least a portion of the water and nutrients 138 flowing through the back through-channel 310. Thus, the back through-channel 310 provides a second pathway for the water and nutrients 138 to reach the roots of the plants 114 supported by the back face plate 220B. The water and nutrients 138 travel through the baskets 240 (see FIGS. 7 and 9), which each include one or more openings 368 (see FIG. 9) for the water and nutrients 138 to travel through or are otherwise permeable to the water and nutrients 138, so that the water and nutrients 138 reach the roots of the plants 114 supported by the front and back face plates 220F and 220B.

Referring to FIG. 12, the connector portion 352 includes a vertically oriented open-ended channel 370 configured to engage the lower portion 330 below the curved intermediate portion 332 of the hook 224. The connector portion 352 includes through-holes 372A-372D configured to receive fasteners 374A-374D. The connector portion 352 of the front irrigation funnel 226F is configured to be positioned on an opposite side of the lower portion 330 of the hook 224 from the connector portion 352 of the back irrigation funnel 226B with the open-ended channels 370 of the front and back irrigation funnels 226F and 226B engaging the lower portion 330 of the hook 224. When the front and back irrigation funnels 226F and 226B are in this orientation, the through-hole 372A of front irrigation funnel 226F is aligned with the through-hole 372B of the back irrigation funnel 226B and the fastener 374A may inserted into the through-hole 372A of the front irrigation funnel 226F and the through-hole 372B of the back irrigation funnel 226B. Similarly, the through-hole 372B of the front irrigation funnel 226F is aligned with the through-hole 372A of the back irrigation funnel 226B and the fastener 374B may inserted into the through-hole 372B of the front irrigation funnel 226F and the through-hole 372A of the back irrigation funnel 226B. At the same time, the through-hole 372C of the front irrigation funnel 226F is aligned with the through-hole 372D of the back irrigation funnel 226B and the fastener 374C may inserted into the through-hole 372C of the front irrigation funnel 226F and the through-hole 372D of the back irrigation funnel 226B. Further, the through-hole 372D of the front irrigation funnel 226F is aligned with the through-hole 372C of the back irrigation funnel 226B and the fastener 374D may inserted into the through-hole 372D of the front irrigation funnel 226F and the through-hole 372C of the back irrigation funnel 226B. Thus, the fasteners 374A-374D may be used to clamp the front and back irrigation funnels 226F and 226B to the lower portion 330 of the hook 224. The front and back irrigation funnels 226F and 226B may be clamped to the lower portion 330 of the hook 224 at a position above the top portion 260 of the tower frame 222. In other words, the front and back irrigation funnels 226F and 226B may be spaced apart vertically from the tower frame 222 and the track 202 (see FIGS. 4, 6, and 16).

By way of a non-limiting example, the system 100 may be operated as follows. Referring to FIG. 7, the seeds 244 are allowed to germinate in the growth media 242 to create the plants 114 (see FIGS. 1, 6, 9, and 13), which at this stage may be characterized as being seedlings. By way of a non-limiting example, this may occur in the region 107 (see FIG. 2). Then, referring to FIG. 9, the tower frame 222 may be placed on its first side portion 274 or its second side portion 276 on a conveyor belt 400. The front and back face plates 220F and 220B are slid into place. The pins 266 may be inserted into the through-holes 264 positioned near the bottom portion 262 of the tower frame 222 before, during, or after the front and back face plates 220F and 220B are slid into place. The pins 266 help maintain the front and back face plates 220F and 220B in place in the tower frame 222.

As mentioned above, the seeds 244 (see FIG. 7) may germinate inside the baskets 240 of the front and back face plates 220F and 220B. Alternatively, the seeds 244 may germinate in the growth media 242 before the growth media 242 is placed inside the baskets 240. In such embodiments, human workers and/or one or more automated planting robots (e.g., the robot 160 illustrated in FIGS. 1-4) may place the growth media 242 (with the germinated plants 114 therein) in the baskets 240 of the front and back face plates 220F and 220B. This may be done before or after the front and back face plates 220F and 220B are slid into place in the tower frame 222.

Referring to FIG. 10, if the hook 224 is disconnected from the tower frame 222, the hook 224 may be inserted into the central through-channel 294 and attached to the top portion 260 of the tower frame 222. The front and back irrigation funnels 226F and 226B may already be attached to the hook 224 or may be attached at this point. Then, referring to FIG. 6, the robot 160 (see FIGS. 1-4 and 16) may lift the vertical grow tower assembly 112A and attach the hook 224 to the load bar 206. This process may be repeated for each of the vertical grow tower assemblies 112B-112F. Then, the carrier assembly 200A may be moved along the overhead conveyor system 110 to another location in the region R2 (see FIGS. 1 and 2) whereat the front and back irrigation funnels 226F and 226B are positioned to receive the water and nutrients 138 (see FIG. 13) from the water pipes 132 (see FIGS. 1 and 13) of the watering system 130 (see FIG. 1) and the plants 114 are allowed to grow.

When it is time to harvest the plants 114, the carrier assembly 200A may be moved along the overhead conveyor system 110 to the region R1 (see FIGS. 1, 2, and 4) whereat the robot 160 (see FIGS. 1-4 and 16) detaches the hook 224 from the load bar 206 and may lower the vertical grow tower assembly 112A to a harvesting conveyor belt (like the conveyor belt 400 illustrated in FIG. 9). This process may be repeated for each of the vertical grow tower assemblies 112B-112F. Human workers and/or one or more automated harvesting robots (e.g., the robot 160) may remove the plants 114 from the vertical grow tower assemblies 112A-112F. By way of a non-limiting example, this may occur in the region 108 (see FIG. 2). The human workers and/or the automated harvesting robot(s) remove the pins 266 from the through-holes 264 and slide the front and back face plates 220F and 220B free of the tower frame 222. At this point, the front and back face plates 220F and 220B and the tower frame 222 may be cleaned in accordance with applicable food safety laws and regulations. If required, the hook 224 and the front and back irrigation funnels 226F and 226B may also be cleaned. While the front and back face plates 220F and 220B and the tower frame 222 are being cleaned, different ones of the vertical grow tower assemblies 112 that include newly germinated plants may be hung from the load bar 206. In this manner, the system 100 (see FIGS. 1 and 16) may be continuously growing the plants 114.

Referring to FIG. 9, in the food industry, food safety is paramount. As a result, all materials that touch the plants 114 must be cleaned regularly. Cleaning each of the vertical grow tower assemblies 112 (see FIGS. 1, 4, 6, and 16) is cumbersome and time consuming. Because the front and back face plates 220F and 220B are configured to be removable from the tower frame 222, the front and back face plates 220F and 220B may be cleaned separately.

The front face plate 220F is configured to slide into and out of the first and second grooves 280 and 282 and the back face plate 220B is configured to slide into and out of the third and fourth grooves 284 and 286 to increase the efficiency at which the plants 114 may be planted and harvested. Thus, instead of harvesting single plants one at a time from the vertical grow tower assembly 112A, a machine (e.g., the robot 160 illustrated in FIGS. 1-4) may be configured to slide the front face plate 220F and the back face plate 220B into and out of the tower frame 222. Referring to FIG. 1, using the robot 160 in this manner decreases an amount of time during which the vertical grow tower assemblies 112 are removed from the overhead conveyor system 110 and, consequently, are not growing the plants 114. Thus, by decreasing the amount of time required to harvest the plants 114, an amount of time during which the vertical grow tower assemblies 112 are growing the plants 114 may be increased, which will increase the yield of the system 100.

### Computing Device

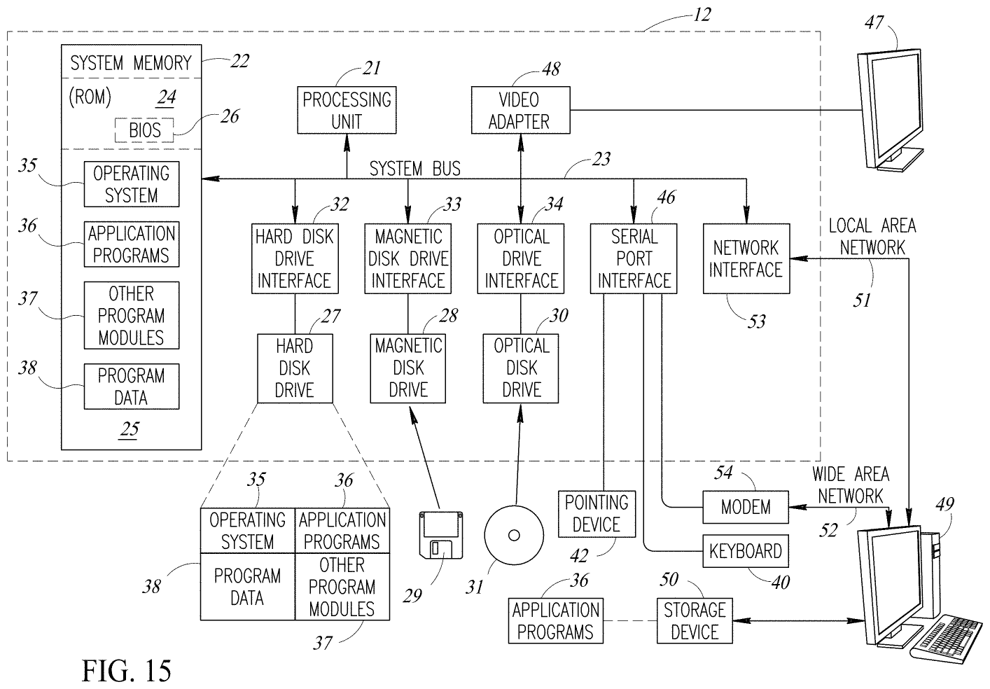

FIG. 15 is a diagram of hardware and an operating environment in conjunction with which implementations of the one or more computing devices of the system 100 may be practiced. The description of FIG. 15 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 15 includes a general-purpose computing device in the form of the computing device 12. Each of the computer system(s) 150 of FIG. 1 may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42.

Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 15 include a local-area network (LAN) 51 and a wide-area network (WAN) 52. Such networking environments are commonplace in offices, enterprise-wide computer networks, intranets and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

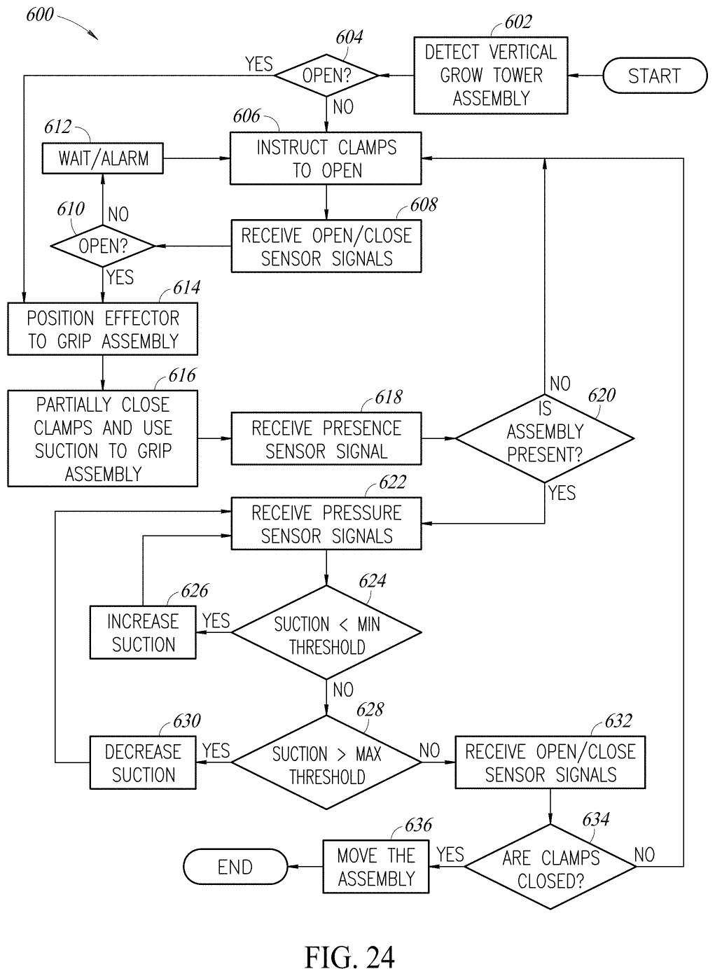

In some embodiments, the system memory 22 stores the application 152, which includes computer executable instructions that when executed by one or more processors cause the one or more processors to perform the functions and all or portions of one or more of the methods described herein, including a method 600 illustrated in FIG. 24. Such instructions may be stored on one or more non-transitory computer-readable media.

### Effector

FIG. 16 is a perspective view of an effector 500, which may be characterized as being a gripping element or tool configured to be installed on the robot 160, which in the embodiment illustrated in FIG. 16 has been implemented as a robotic arm 501 with a free end 502. By way of non-limiting examples, the robotic arm 501 may be implemented as a FANU R-2000Ia/165F sold by FANUC America Corporation, a robotic arm manufactured by ABB (which operates a website at https://new.abb.com/), or the like. The effector 500 is configured to be installed on the free end 502 of the robotic arm 501. As mentioned above, the application 152 (see FIG. 1) may be configured to control the robot 160. The robotic arm 501 may be configured to be controlled by the application 152 executing on the computer system(s) 150, which together may be characterized as being a control system. The application 152 and/or the robotic arm 501 may be operated by a technician 504 and/or an autonomously executing computer program.

The effector 500 may be configured for use with the hydroponic vertical farm system 100, which includes the overhead conveyor system 110 from which the vertical grow tower assemblies 112 may be hung. As described above, the overhead conveyor system 110 may include the carrier assemblies 200 (e.g., carrier assemblies 200A and 200B), which are each configured to travel along the (overhead) track 202. A predetermined number (e.g., six) of the vertical grow tower assemblies 112 (e.g., the vertical grow tower assemblies 112A-112F) may be hung together side-by-side on each of the carrier assemblies 200. The effector 500 may be configured to grip one of the vertical grow tower assemblies 112 and add the gripped vertical grow tower assembly to one of the carrier assemblies 200 and/or remove the gripped vertical grow tower assembly from a carrier assembly. For ease of illustration, the effector 500 will be described as gripping the vertical grow tower assembly 112A but the effector 500 may be used to grip each of the vertical grow tower assemblies 112 one at a time. Further, the effector 500 will be described as adding the vertical grow tower assembly 112A to the carrier assembly 200A and removing the vertical grow tower assembly 112A from the carrier assembly 200A. However, the effector 500 may be used to grip each of the vertical grow tower assemblies 112 and add the vertical grow tower assembly to or remove the vertical grow tower assembly from any of the carrier assemblies 200.

As mentioned above, each of the carrier assemblies 200 may include the seats 216A-216F (see FIG. 14) and the seats 217A-217F (see FIG. 14) with the seats 216A-216F being aligned with the seats 217A-217F, respectively. The upper portion 334 (see FIGS. 10, 11, and 14) of each of the vertical grow tower assemblies 112A-112F may be seated in an aligned pair of the seats 216A-216F and 217A-217F. For example, the upper portion 334 of the vertical grow tower assembly 112A may be seated in the seats 216A and 217A with the anchor projection 340 (see FIGS. 10, 11, and 14) of the vertical grow tower assembly 112A positioned between the first and second rails 212 and 213 (see FIGS. 6 and 14). Similarly, the upper portion 334 of the vertical grow tower assembly 112B may be seated in the seats 216B and 217B, and so forth.

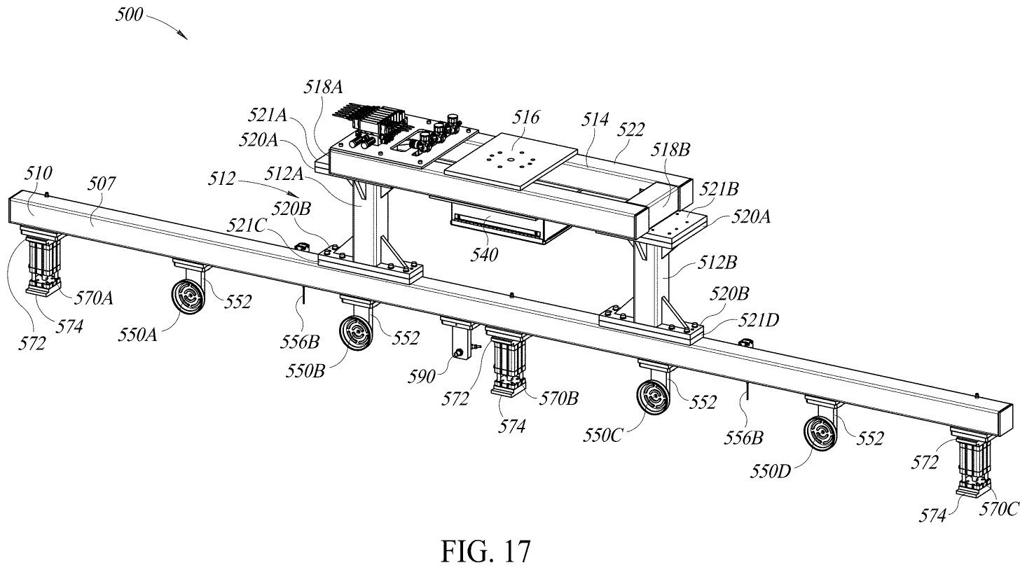

The effector 500 has a front gripping side 507 (see FIG. 17) opposite a back side 508. The effector 500 may remove the vertical grow tower assembly 112A from the carrier assembly 200A by gripping either the first side portion 274 (see FIGS. 8B, 9, and 19) or the second side portion 276 (see FIGS. 8B, 9, 19, and 21) of the tower frame 222 of the vertical grow tower assembly 112A along the front gripping side 507 of the effector 500 and lifting the vertical grow tower assembly 112A until the anchor projection 340 (see FIGS. 10, 11, and 14) of the vertical grow tower assembly 112A is clear of the carrier assembly 200A. The effector 500 may remove the vertical grow tower assemblies 112B-112F from the carrier assembly 200A by repeating this operation for each of the vertical grow tower assemblies 112B-112F. By way of another non-limiting example, when the upper portion 334 (see FIGS. 10, 11, and 14) of the vertical grow tower assembly 112A is not seated in the seats 216A and 217A (see FIG. 14) of the carrier assembly 200A, the effector 500 may grip either the first side portion 274 or the second side portion 276 of the tower frame 222 of the vertical grow tower assembly 112A, lift the vertical grow tower assembly 112A above the carrier assembly 200A, position the anchor projection 340 laterally in between the first and second rails 212 and 213 (see FIGS. 6 and 14) of the carrier assembly 200A, and lower the vertical grow tower assembly 112A until the upper portion 334 is seated in the seats 216A and 217A (see FIG. 14) of the carrier assembly 200A. The effector 500 may add the vertical grow tower assemblies 112B-112F to the carrier assembly 200A by repeating this operation for each of the vertical grow tower assemblies 112B-112F.

Referring to FIG. 17, the effector 500 is configured to both vacuum clamp and laterally mechanically clamp onto one of the vertical grow tower assemblies 112 (see FIGS. 1, 4, 6, and 16) along the front gripping side 507 of the effector 500. As mentioned above, for ease of illustration, the effector 500 has been illustrated and will be described as being used to clamp onto the vertical grow tower assembly 112A. But, the effector 500 may be used to clamp onto any of the vertical grow tower assemblies 112.

The effector 500 includes a manifold 510, one or more transverse members 512, an assembly 514, and a connector 516. In FIG. 17, the connector 516 has been implemented as a mounting plate configured to be attached to the free end 502 (see FIG. 16) of the robotic arm 501 (see FIG. 16). By way of a non-limiting example, the mounting plate may be attached to the free end 502 by fasteners, such as bolts, screws, and the like. The connector 516 is configured to be attached to both the assembly 514 and the free end 502 (see FIG. 16) of the robotic arm 501 (see FIG. 16).

The assembly 514 has a first end portion 518A opposite a second end portion 518B. In the embodiment illustrated, the transverse member(s) 512 include transverse members 512A and 512B, which are attached to the first and second end portions 518A and 518B, respectively, of the assembly 514 opposite the connector 516. The transverse members 512A and 512B may each extend outwardly substantially perpendicularly from the assembly 514 and the transverse members 512A and 512B may be substantially parallel to one another. The transverse members 512A and 512B each have a first end portion 520A opposite a second end portion 520B. The first end portions 520A of the transverse members 512A and 512B are attached to the first and second end portions 518A and 518B, respectively, of the assembly 514 (e.g., by fasteners such as bolts, screws, and the like). The second end portions 520B of the transverse members 512A and 512B are each attached to the manifold 510 (e.g., by welding or by fasteners such as bolts, screws, and the like). The manifold 510 may extend substantially perpendicularly with respect to the transverse members 512A and 512B.

In the embodiment illustrated, the first end portion 518A of the assembly 514 includes a first plate 521A configured to be coupled to the first end portion 520A of the transverse member 512A, and the second end portion 518B of the assembly 514 includes a second plate 521B configured to be coupled to the first end portion 520A of the transverse member 512B. Further, the manifold 510 includes a third plate 521C configured to be coupled to the second end portion 520B of the transverse member 512A, and the manifold 510 includes a fourth plate 521 D configured to be coupled to the second end portion 520B of the transverse member 512B.

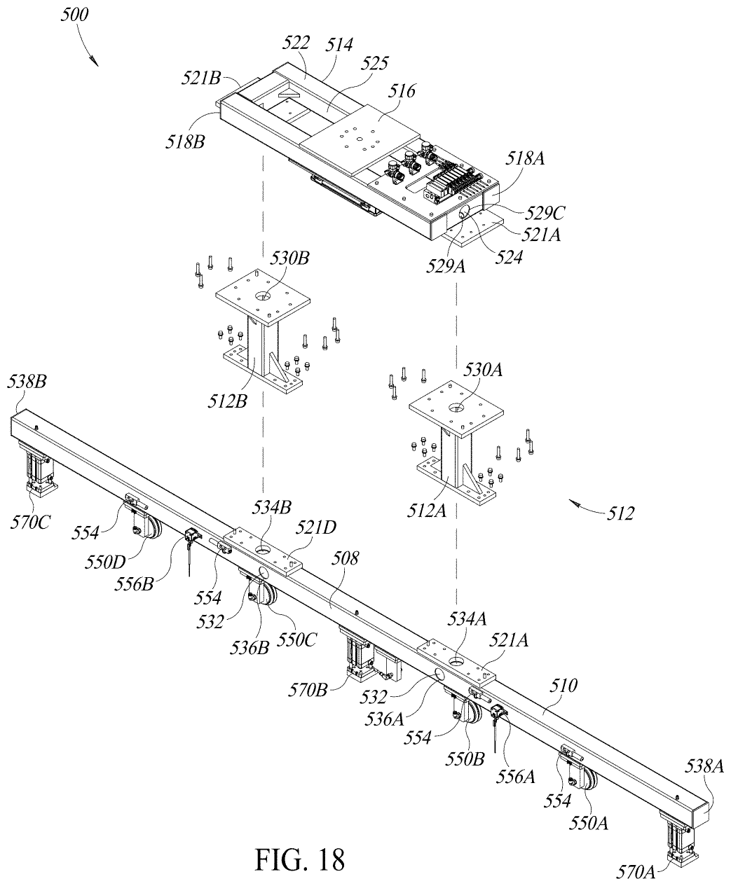

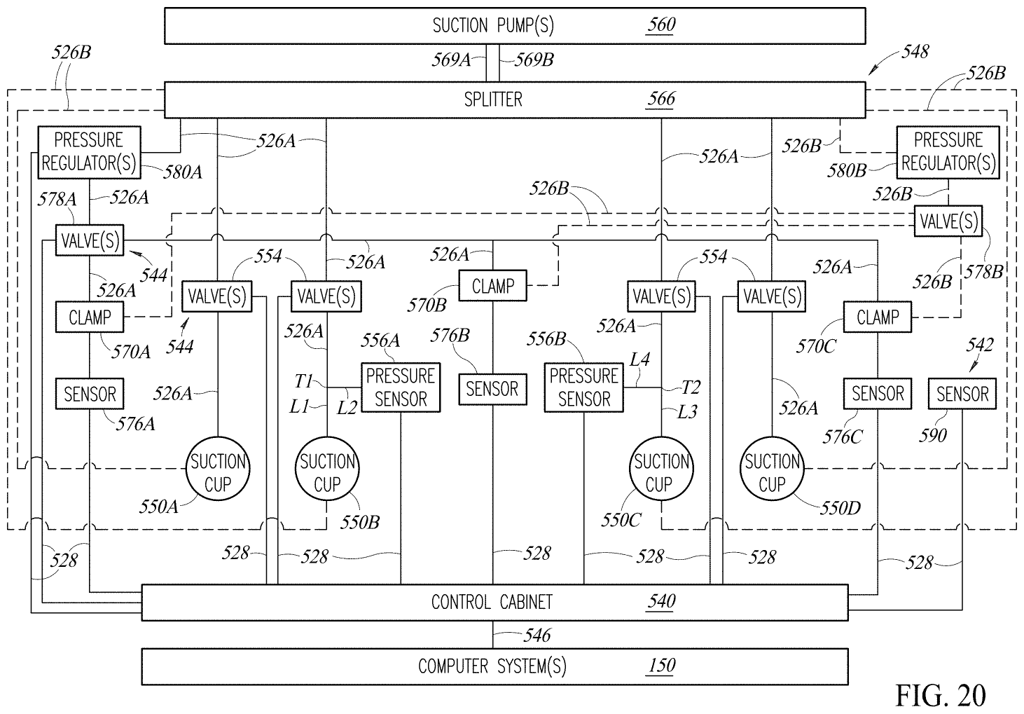

Referring to FIG. 18, the assembly 514 includes a frame 522 with one or more internal passageways 524 configured to allow inlet suction lines 526A (see FIG. 20) and/or return suction lines 526B (see FIG. 20) to enter the frame 522 and pass therethrough. Optionally, communication lines 528 (see FIG. 20) may also pass through the internal passageway(s) 524. The connector 516 may be mounted on the frame 522. For ease of illustration, the inlet suction lines 526A, the return suction lines 526B, and the communication lines 528 have been omitted from FIGS. 17-19 and 21-23.

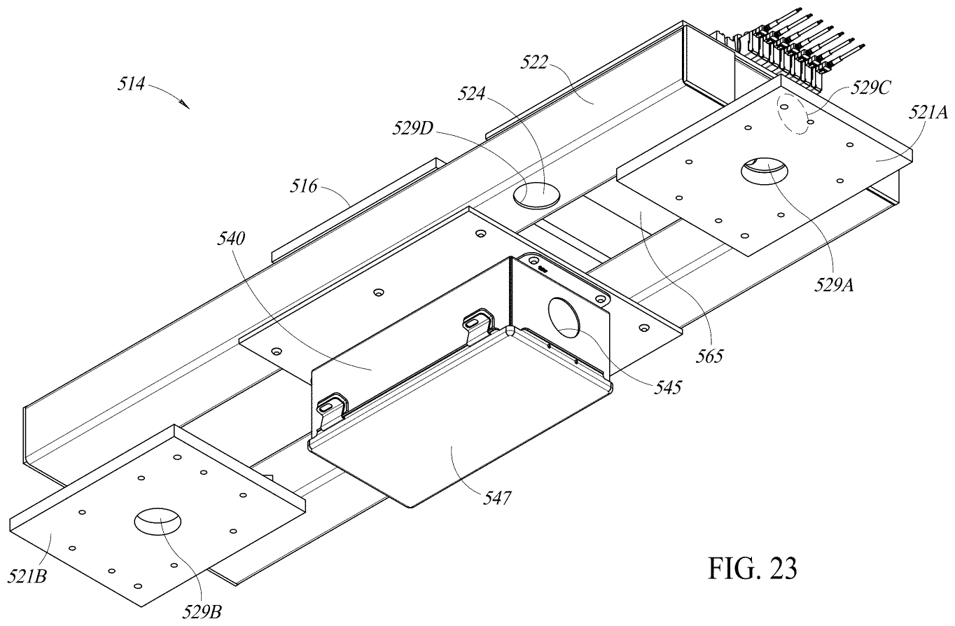

In the embodiment illustrated, the frame 522 has a generally rectangular outer shape and may be constructed from hollow tubing. The hollow tubing may have a generally square cross-sectional shape. In the embodiment illustrated, the frame 522 defines a central opening 525 that allows the inlet suction lines 526A, the return suction lines 526B, and/or the communication lines 528 to pass therethrough. Referring to FIG. 23, at least one through-hole (e.g., through-holes 529A-529C) may be formed in the frame 522 to provide access to the internal passageway(s) 524 for the inlet suction lines 526A, the return suction lines 526B, and/or the communication lines 528.

Referring to FIG. 18, the through-holes 529A and 529B (see FIG. 23) formed in the frame 522 are aligned with through-channels 530A and 530B, respectively, formed in the transverse members 512A and 512B, respectively. The first and second plates 521A and 521B may be attached (e.g., welded) to the underside of the frame 522 at the first and second end portions 518A and 518B, respectively, of the assembly 514. In such embodiments, the through-holes 529A and 529B extend through the first and second plates 521A and 521B, respectively, and allow the inlet suction lines 526A (see FIG. 20), the return suction lines 526B (see FIG. 20), and/or the communication lines 528 (see FIG. 20) to pass from the frame 522 through to the transverse members 512A and 512B, respectively.

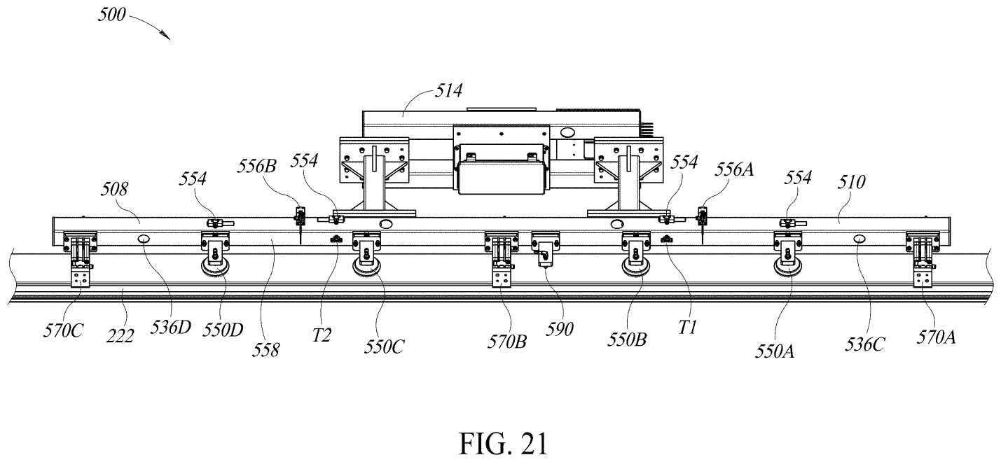

The manifold 510 may include one or more internal channels 532 having inlets 534A and 534B that are aligned with the through-channels 530A, and 530B, respectively. The manifold 510 include openings 536A and 536B in communication with the internal channel(s) 532. Referring to FIG. 21, the manifold 510 may also include openings 536C and 536D in communication with the internal channel(s) 532. The openings 536A-536D allow the inlet suction lines 526A (see FIG. 20), the return suction lines 526B (see FIG. 20), and/or the communication lines 528 (see FIG. 20) to enter and exit the internal channel(s) 532 formed in the manifold 510. By way of a non-limiting example, the manifold 510 may be constructed from a hollow tube that is closed at its first and second ends 538A and 538B. The hollow tubing may have a generally square cross-sectional shape. The third and fourth plates 521C and 521D may be attached (e.g., welded) to the manifold 510. In such embodiments, the inlets 534A and 534B extend through the third and fourth plates 521C and 521D, respectively, and allow the inlet suction lines 526A, the return suction lines 526B, and/or the communication lines 528 to pass from the transverse members 512A and 512B, respectively, and into the manifold 510.

Referring to FIG. 17, the assembly 514 includes a control cabinet 540 mounted on the frame 522. The control cabinet 540 is configured to house relays (not shown) and terminal blocks (not shown) for each of a plurality of sensors 542 (see FIG. 20) and a plurality of valves 544 (see FIG. 20). The control cabinet 540 may be positioned on the frame 522 opposite the connector 516 and in between the transverse members 512A and 512B. The entire electrical system may be housed inside or may pass through the control cabinet 540. The communication lines 528 conduct sensor signals from the sensors 542 and valve signals from the valves 544 into the control cabinet 540 whereat the communication lines 528 may be connected together (e.g., in a single cable 546 illustrated in FIG. 20) to simplify wiring. The control cabinet 540 includes one or more through-holes 545 through which the communication lines 528 and/or the cable 546 may enter or exits a hollow interior (not shown) of the control cabinet 540. In the embodiment illustrated, the control cabinet 540 includes a door 547 that is hingedly attached to an opening (not shown) into the hollow interior (not shown) of the control cabinet 540.

FIG. 20 is a block diagram illustrating components 548 of the effector 500 (see FIGS. 16-19 and 21) that vacuum clamp and mechanically clamp onto the vertical grow tower assembly 112A (see FIGS. 4, 6, 9, 10, and 16). In FIG. 20, the inlet suction lines 526A and the communication lines 528 have been illustrated with solid lines, and the return suction lines 526B have been illustrated with dashed lines. Those of the components 548 that implement vacuum clamping include one or more suction cups 550A-550D. Referring to FIG. 17, the suction cup(s) 550A-550D may each be mounted on the manifold 510 by a suction cup mount 552. Referring to FIG. 18, the valves 544 (see FIG. 20) include one or more valves 554 positioned on the manifold 510. Referring to FIG. 20, the suction cup(s) 550A-550D may each be connected to a separate one of the valve(s) 554, which controls an amount of suction supplied to the suction cup. Thus, the valve(s) 554 also control at least in part an amount of suction supplied by the suction cup(s) 550A-550D. In the embodiment illustrated in FIG. 17, the suction cup(s) 550A-550D include four bellows-type suction cups configured to be anti-surface regularity. In other words, the each of bellows-type suction cups is configured to grip irregular surfaces. Each of the suction cup(s) 550A-550D may have a load capacity of about 395 N at a pressure of about 7 bar. Referring to FIG. 20, the inlet suction lines 526A provide suction to the suction cup(s) 550A-550D via the valve(s) 554. The inlet suction lines 526A may be connected to one or more vacuum or suction pumps 560 configured to supply suction to the inlet suction lines 526A. The suction pump(s) 560 may be mounted on the effector 500 (see FIGS. 16-19 and 21), the robotic arm 501 (see FIG. 16), and/or separately from both of these components.

The sensors 542 include one or more pressure sensors 556A and 556B configured to detect a working range of the suction cup(s) 550A-550D. In other words, the pressure sensors 556A and 556B detect how much suction the suction cup(s) 550A-550D are supplying. This information is used by the application 152 (see FIG. 1) executing on the computer system(s) 150 to determine whether the suction cup(s) 550A-550D have enough suction to adequately grip the vertical grow tower assembly 112A (see FIGS. 4, 6, 9, 10, and 16). Referring to FIG. 18, the pressure sensor(s) 556A and 556B may be mounted on the back side 508 of the manifold 510.

In the embodiment illustrated in FIG. 21, T-shaped connectors T1 and T2 are mounted on an underside 558 of the manifold 510. The underside 558 of the manifold 510 may also include the openings 536C and 536D. Referring to FIG. 20, the T-shaped connector T1 splits the inlet suction line 526A connecting the valve 554 to the suction cup 550B into lines L1 and L2. The line L1 is connect to the suction cup 550B and the line L2 is connected to the pressure sensor 556A. Similarly, the T-shaped connector T2 splits the inlet suction line 526A connecting the valve 554 to the suction cup 550C into lines L3 and L4. The line L3 is connect to the suction cup 550C and the line L4 is connected to the pressure sensor 556B.

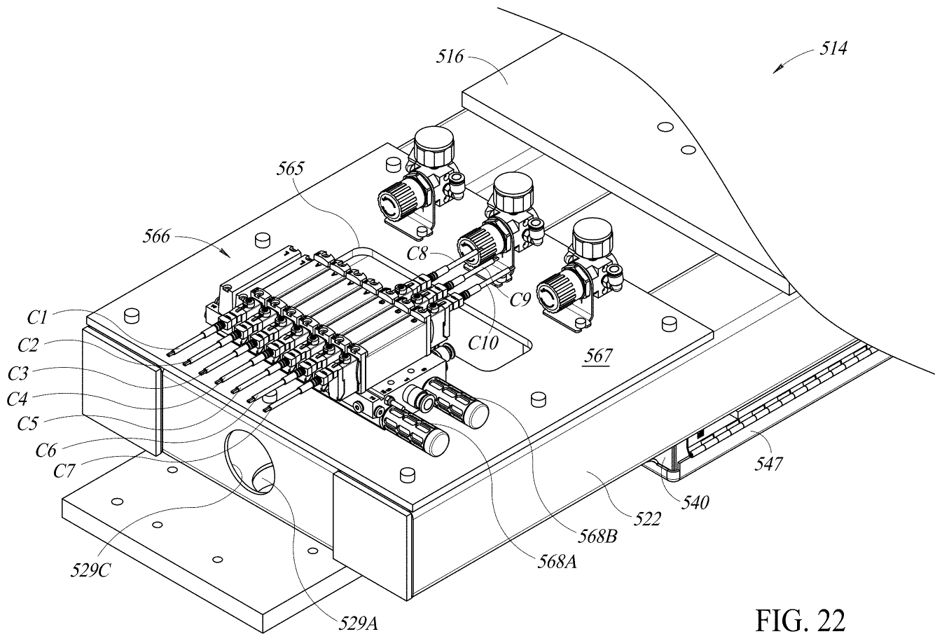

The suction pump(s) 560 may be connected to a splitter 566. Referring to FIG. 22, the splitter 566 may be mounted on the frame 522 (e.g., by a plate 567). The splitter 566 may have an inlet 568A and an outlet 568B configured to be connected to the suction pump(s) 560 by an inlet suction line 569A (see FIG. 20) and an outlet or return suction line 569B (see FIG. 20). The splitter 566 includes connectors C1-05 configured to be connected to the inlet suction lines 526A (see FIG. 20) and connectors C6-C10 configured to be connected to the return suction lines 526B (see FIG. 20). The splitter 566 is configured to divide suction provided to the inlet 568A (by the inlet suction line 569A) to each of the connectors C1-05, which provide the suction to the inlet suction lines 526A. The splitter 566 is also configured to combine suction provided by the return suction lines 526B to the connectors C6-C10, respectively, and provide the combined return suction to the outlet 568B, which in turn provides the combined return suction to the return suction line 569B. In the embodiment illustrated, the plate 567 has a through-hole 565 that helps provide access to the connectors C1-C10 for the inlet suction lines 526A and/or the return suction lines 526B.

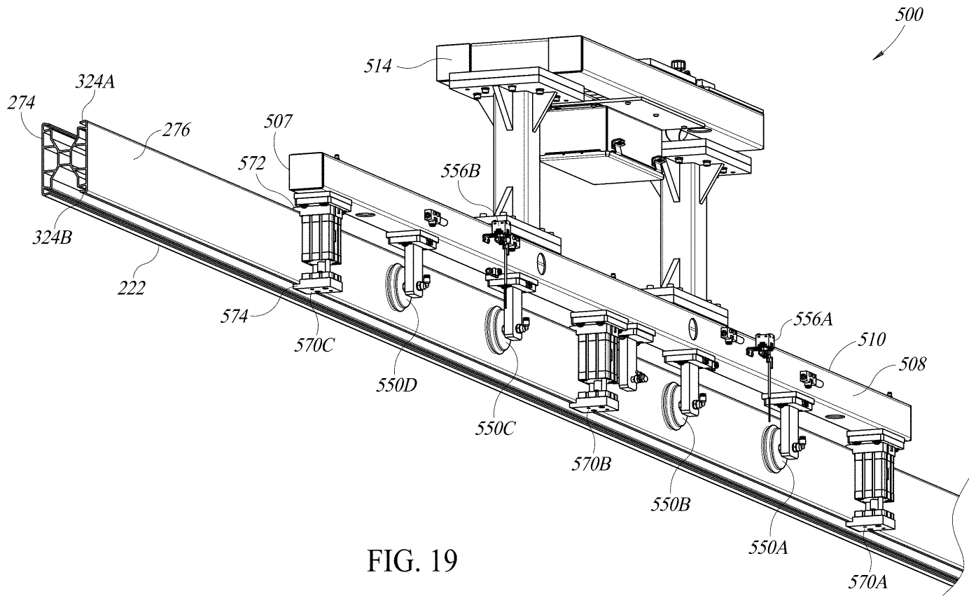

Referring to FIG. 20, those of the components 548 that implement mechanical clamping include one or more clamps 570A-570C. In other words, referring to FIG. 19, the clamp(s) 570A-570C may laterally and mechanically clamp onto the tower frame 222 of the vertical grow tower assembly 112A (see FIGS. 4, 6, 9, 10, and 16). Thus, the effector 500 may vacuum clamp onto the tower frame 222 with the suction cup(s) 550A-550D and simultaneously mechanically clamp onto the tower frame 222 with the clamp(s) 570A-570C. The clamp(s) 570A-570C may be configured to hold the vertical grow tower assembly 112A and center the vertical grow tower assembly 112A with respect to the suction cup(s) 550A-550D.

Each of the clamp(s) 570A-570C may include a stationary jaw 572 and a movable jaw 574 configured to be moved by suction provided by the suction pump(s) 560 (see FIG. 20). Each of the clamp(s) 570A-570C is configured to grip onto the first side portion 274 or the second side portion 276 of the tower frame 222. In FIG. 19, the clamp(s) 570A-570C are illustrated gripping the second side portion 276. In this configuration, the stationary jaw 572 extends alongside the first flange 324A and the movable jaw 574 extends alongside the second flange 324B. Each of the clamp(s) 570A-570C may be implemented as a gripping cylinder, such as a guided-type cylinder. Referring to FIG. 20, the sensors 542 may include one or more sensors 576A-576C (e.g., stroke sensors). The sensors 576A-576C may be implemented as components of the clamp(s) 570A-570C, respectively, or may be implemented as separate components. The sensors 576A-576C are configured to detect whether the clamp(s) 570A-570C, respectively, are each in an open position or a closed position.

The valves 544 may include one or more valves connected to the clamp(s) 570A-570C. For example, the valves 544 may include two independent valves 578A and 578B. The valve 578A may be connected to those of the inlet suction lines 526A that supply suction to the clamp(s) 570A-570C and the valve 578B may be connected to those of the return suction lines 526B that return suction from the clamp(s) 570A-570C. The valves 578A and 578B may be connected to pressure regulators 580A and 580B, respectively, that provide force control at the moment the clamp(s) 570A-570C close and grip onto the vertical grow tower assembly 112A (see FIGS. 4, 6, 9, 10, and 16).

Referring to FIG. 17, the effector 500 may include a sensor 590 (e.g., a capacitive sensor) configured to detect the presence of the vertical grow tower assembly 112A (see FIGS. 4, 6, 9, 10, and 16) when the effector 500 grips the vertical grow tower assembly 112A (e.g., to remove the vertical grow tower assembly 112A from the conveyor or the guided track).

FIG. 24 is a flow diagram of the method 600 that may be performed by the application 152 (see FIG. 1) executing on the computer system(s) 150 (see FIGS. 1, 16, and 20). In first block 602, the application 152 detects the vertical grow tower assembly 112A (see FIGS. 4, 6, 9, 10, and 16). Then, in decision block 604, the application 152 determines whether each of the clamp(s) 570A-570C (see FIGS. 17-21) is in the open position. For example, the application 152 may use sensor signals received from the sensors 576A-576C (see FIG. 20) to determine whether the clamp(s) 570A-570C are in open positions. The decision in decision block 604 is “YES” when all of the clamp(s) 570A-570C are in the open position. Otherwise, the decision in decision block 604 is “NO.” When the decision in decision block 604 is “NO,” the application 152 advances to block 606. On the other hand, when the decision in decision block 604 is “YES,” the application 152 advances to block 614.

In block 606, the application 152 (see FIG. 1) sends an instruction to the clamp(s) 570A-570C (see FIGS. 17-21) to open. The clamp(s) 570A-570C attempt to open in response to the open instruction and the sensors 576A-576C (see FIG. 20) send sensor signals to the application 152. In block 608, the application 152 receives the sensor signals from the sensors 576A-576C. Then, in decision block 610, the application 152 uses the sensor signals received from the sensors 576A-576C to determine whether each of the clamp(s) 570A-570C is in the open position. The decision in decision block 610 is “YES” when all of the clamp(s) 570A-570C are in the open position. Otherwise, the decision in decision block 610 is “NO.” When the decision in decision block 610 is “NO,” the application 152 advances to block 612. On the other hand, when the decision in decision block 610 is “YES,” the application 152 advances to block 614.

In block 612, the application 152 (see FIG. 1) may take an appropriate action. For example, the application 152 may wait to give the clamp(s) 570A-570C (see FIGS. 17-21) additional time to open, trigger an alarm to alert the technician 504 (see FIG. 16) that a problem has occurred, or the method 600 may terminate.

In block 614, the application 152 (see FIG. 1) positions the effector 500 (see FIGS. 16-19 and 21) to grip the vertical grow tower assembly 112A (see FIGS. 4, 6, 9, 10, and 16). For example, referring to FIG. 19, the application 152 (see FIG. 1) may position the stationary jaw 572 of each of the clamp(s) 570A-570C (see FIGS. 17-21) alongside the first flange 324A and the movable jaw 574 of each of the clamp(s) 570A-570C alongside the second flange 324B. Then, in block 616 (see FIG. 24), the application 152 sends an instruction to the clamp(s) 570A-570C to close. The clamp(s) 570A-570C attempt to close in response to the close instruction to thereby grip the vertical grow tower assembly 112A and the sensor 590 (see FIGS. 17, 20, and 21) sends a presence sensor signal to the application 152. As mentioned above, the pressure regulators 580A and 580B (see FIG. 20) may provide force control as the clamp(s) 570A-570C close and attempt to grip onto the vertical grow tower assembly 112A (see FIGS. 4, 6, 9, 10, and 16). Referring to FIG. 24, in block 618, the application 152 (see FIG. 1) receives the presence sensor signal from the sensor 590 (see FIGS. 17, 20, and 21).

Then, in decision block 620, the application 152 (see FIG. 1) uses the presence sensor signal received from the sensor 590 (see FIGS. 17, 20, and 21) to determine whether the vertical grow tower assembly 112A (see FIGS. 4, 6, 9, 10, and 16) is present and is therefore being gripped by the clamp(s) 570A-570C (see FIGS. 17-21). The decision in decision block 620 is “YES” when the vertical grow tower assembly 112A is present. Otherwise, the decision in decision block 620 is “NO.” When the decision in decision block 620 is “NO,” the application 152 returns to block 606 and attempts to grip the vertical grow tower assembly 112A again. On the other hand, when the decision in decision block 620 is “YES,” the application 152 advances to block 622.

In block 622, the application 152 (see FIG. 1) receives pressure signals from the pressure sensors 556A and 556B (see FIGS. 17-19 and 21). Then, in decision block 624, the application 152 uses the pressure signals to determine whether an amount of suction being applied by the suction cup(s) 550A-550D (see FIGS. 17-21) to the vertical grow tower assembly 112A (see FIGS. 4, 6, 9, 10, and 16) is less than a minimum threshold value. The decision in decision block 624 is “YES” when the amount of suction is less than the minimum threshold value. Otherwise, the decision in decision block 624 is “NO.”

When the decision in decision block 624 is “YES,” the application 152 (see FIG. 1) advances to block 626 and increases the amount of suction being applied by the suction cup(s) 550A-550D (see FIGS. 17-21) to the vertical grow tower assembly 112A (see FIGS. 4, 6, 9, 10, and 16). For example, the application 152 may increase the amount of suction being applied by the suction cup(s) 550A-550D by instructing the valve(s) 554 (via the communication lines 528 illustrated in FIG. 20) to allow more suction to reach the suction cup(s) 550A-550D. Then, the application 152 returns to block 622.

On the other hand, when the decision in decision block 624 is “NO,” the application 152 (see FIG. 1) advances to decision block 628. In decision block 628, the application 152 uses the pressure signals received from the pressure sensors 556A and 556B (see FIGS. 17-19 and 21) to determine whether the amount of suction being applied by the suction cup(s) 550A-550D (see FIGS. 17-21) to the vertical grow tower assembly 112A (see FIGS. 4, 6, 9, 10, and 16) exceeds a maximum threshold value. The decision in decision block 628 is “YES” when the amount of suction exceeds the maximum threshold value. Otherwise, the decision in decision block 628 is “NO.”

When the decision in decision block 628 is “YES,” the application 152 (see FIG. 1) advances to block 630 and decreases the amount of suction being applied by the suction cup(s) 550A-550D (see FIGS. 17-21) to the vertical grow tower assembly 112A (see FIGS. 4, 6, 9, 10, and 16). For example, the application 152 may decrease the amount of suction being applied by the suction cup(s) 550A-550D by instructing the valve(s) 554 (via the communication lines 528 illustrated in FIG. 20) to allow less suction to reach the suction cup(s) 550A-550D. Then, the application 152 returns to block 622. On the other hand, when the decision in decision block 624 is “NO,” the application 152 advances to block 632.

In block 632, the application 152 (see FIG. 1) receives open/closed signals from the sensors 576A-576C (see FIG. 20). Then, in decision block 634, the application 152 uses the open/closed signals received in block 632 to determine whether each of the clamp(s) 570A-570C (see FIGS. 17-21) is in the closed position. The decision in decision block 634 is “YES” when all of the clamp(s) 570A-570C are in the closed position. Otherwise, the decision in decision block 634 is “NO.” At this point, the closed position is a position in which the stationary and movable jaws 572 and 574 of the clamp(s) 570A-570C are close enough to one another to grip the vertical grow tower assembly 112A (see FIGS. 4, 6, 9, 10, and 16).

When the decision in decision block 634 is “NO,” the application 152 (see FIG. 1) returns to block 606 and attempts to grip the vertical grow tower assembly 112A (see FIGS. 4, 6, 9, 10, and 16) again. On the other hand, when the decision in decision block 634 is “YES,” the application 152 advances to block 636.

In block 636, referring to FIG. 16, the application 152 (see FIG. 1) moves the robotic arm 501 to position the effector 500, which is gripping the vertical grow tower assembly 112A, to thereby position the vertical grow tower assembly 112A. For example, the effector 500 may hang the vertical grow tower assembly 112A on the carrier assembly 200A positioned on the (overhead) track 202 or may remove the vertical grow tower assembly 112A from the carrier assembly 200A positioned on the (overhead) track 202. Then, the method 600 terminates.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. A gripping tool mountable on a robotic arm, the gripping tool comprising:
a manifold;
one or more suction cups connected to the manifold, the one or more suction cups being oriented to adhere to a surface; and
a plurality of clamps connected to the manifold, the plurality of clamps being oriented to clamp onto opposite edges of the surface.

2. The gripping tool of claim 1, further comprising:
a sensor configured to detect presence of the surface.

3. The gripping tool of claim 2, wherein the sensor is a capacitive sensor.

4. The gripping tool of claim 1, further comprising:
one or more valves each connected to a different one of the one or more suction cups, the one or more valves being connected to a vacuum pump and controlling an amount of suction supplied by the vacuum pump to each of the one or more suction cups.

5. The gripping tool of claim 1, further comprising:
one or more pressure sensors connected to the manifold, the one or more pressure sensors being configured to detect an amount of pressure supplied by the one or more suction cups to the surface.

6. The gripping tool of claim 5, further comprising:
one or more valves each connected to a different one of the one or more suction cups, the one or more valves being connected to a vacuum pump and controlling an amount of suction supplied by the vacuum pump to each of the one or more suction cups; and
a control system configured to receive sensor signals from the one or more pressure sensors indicating the amount of pressure supplied by the one or more suction cups to the surface, the control system being configured to control the amount of pressure supplied by the vacuum pump to each of the one or more suction cups by adjusting at least one of the one or more valves to thereby increase or decrease the amount of pressure supplied by the vacuum pump to the at least one valve.

7. The gripping tool of claim 1, wherein the one or more suction cups comprise a plurality of bellows-type suction cups.

8. The gripping tool of claim 1, further comprising:
a control system configured to open the plurality of clamps allowing the plurality of clamps to be positioned to clamp onto the opposite edges of the surface, the control system being configured to close the plurality of clamps causing the plurality of clamps to clamp onto the opposite edges of the surface after the plurality of clamps have been positioned to clamp onto the opposite edges of the surface.

9. The gripping tool of claim 8, further comprising:
a detection sensor for each of the plurality of clamps configured to detect whether the clamp is in an open position or a closed position and transmit a signal to the control system indicating whether the clamp is in the open position or the closed position.

10. A method comprising:
opening a plurality of clamps of a gripping tool mounted on a robotic arm, the gripping tool comprising one or more suction cups;
positioning the gripping tool with the robotic arm to position the plurality of clamps to grip onto a vertical grow tower assembly;
gripping the vertical grow tower assembly with the plurality of clamps and the one or more suction cups of the gripping tool; and
positioning the gripping tool with the robotic arm to move the vertical grow tower assembly.

11. The method of claim 10, wherein moving the vertical grow tower assembly comprises hanging the vertical grow tower assembly on an overhead track.

12. The method of claim 11, further comprising:
positioning the gripping tool with the robotic arm to remove the vertical grow tower assembly from the overhead track.

13. The method of claim 10, wherein moving the vertical grow tower assembly comprises removing the vertical grow tower assembly from an overhead track.

14. The method of claim 10, wherein the gripping tool comprises a sensor configured to detect presence of the vertical grow tower assembly, and the method further comprises:
receiving a sensor signal from the sensor after gripping the vertical grow tower assembly;
using the sensor signal to determine whether the vertical grow tower assembly is present; and
until the vertical grow tower assembly is determined to be present and before positioning the gripping tool with the robotic arm to move the vertical grow tower assembly, opening the plurality of clamps, repositioning the gripping tool with the robotic arm to position the plurality of clamps to grip onto the vertical grow tower assembly, gripping the vertical grow tower assembly with the plurality of clamps and the one or more suction cups of the gripping tool, receiving a new sensor signal from the sensor, and using the new sensor signal to determine whether the vertical grow tower assembly is present.

15. The method of claim 10, wherein the gripping tool comprises one or more pressure sensors configured to detect an amount of pressure supplied by the one or more suction cups to the vertical grow tower assembly, and the method further comprises:
receiving sensor signals from the one or more pressure sensors after gripping the vertical grow tower assembly;
using the sensor signals to determine an amount of suction being supplied to the one or more suction cups;
increasing the amount of suction being supplied to the one or more suction cups when the amount of suction being supplied is below a minimum threshold amount; and
decreasing the amount of suction being supplied to the one or more suction cups when the amount of suction being supplied is above a maximum threshold amount.

16. The method of claim 15, wherein each of the one or more suction cups is connected to a valve,
increasing the amount of suction being supplied to the one or more suction cups comprises at least partially opening the valve connected to at least one of the one or more suction cups, and
decreasing the amount of suction being supplied to the one or more suction cups comprises at least partially closing the valve connected to at least one of the one or more suction cups.

17. The method of claim 10, wherein the gripping tool comprises a plurality of detection sensors configured to detect whether the plurality of clamps are in an open position or a closed position, and the method further comprises:
after opening the plurality of clamps, receiving a plurality of signals from the plurality of detection sensors indicating whether the plurality of clamps are in the open position or the closed position;
using the plurality of signals to determine whether the plurality of clamps are in the open position or the closed position; and
waiting until the plurality of clamps are in the open position before positioning the gripping tool with the robotic arm to position the plurality of clamps to grip onto the vertical grow tower assembly.

18. The method of claim 17, further comprising:
after opening the plurality of clamps, triggering an alert when it is determined at least one of the plurality of clamps is in the closed position.

19. A hydroponic vertical farm system comprising:
an overhead conveyor;
a plurality of vertical grow tower assemblies each configured to be hung from the overhead conveyor;
a robotic arm comprising a gripping tool having one or more suction cups and a plurality of clamps, the one or more suction cups being oriented to adhere to a surface of a particular tower assembly of the plurality of vertical grow tower assemblies, the plurality of clamps being oriented to clamp onto opposite edges of the surface; and
a control system configured to cause the plurality of clamps to open, cause the robotic arm to position the gripping tool with respect to the particular tower assembly, cause the gripping tool to grip the particular tower assembly with the plurality of clamps, cause the gripping tool to grip the particular tower assembly with the one or more suction cups, and cause the robotic arm to hang the particular tower assembly from the overhead conveyor.

20. The hydroponic vertical farm system of claim 19, wherein the control system is configured to cause the robotic arm to remove the particular tower assembly from the overhead conveyor.
